(19) United States
(12) Patent Application Publication
(10) Pub. No.: US 2026/0291701 A1
(43) Pub. Date: Sep. 24, 2026

(54) SPINAL CODING BASED ON CHANNEL CAPACITY

(71) Applicant: QUALCOMM Incorporated, San Diego, CA (US)

(72) Inventors: David YUNUSOV, Holon (IL); Amit BAR-OR TILLINGER, Tel-Aviv (IL); Shay LANDIS, Hod Hasharon (IL)

(21) Appl. No.: 19/086,915

(22) Filed: Mar. 21, 2025

(51) Int. Cl. H04L 5/00; H04L 27/26

(52) U.S. Cl. CPC H04L 5/0098; H04L 27/2662

(57) ABSTRACT

Aspects of the present disclosure relate generally to implementing spinal coding, in conjunction with multiple transmissions (such as a multiple incremental redundancy scheme (MIRS)), in a channel-aware fashion. For example, a transmitter may identify, based on channel conditions, channel metrics of a set of subcarriers (or other frequency resources). The transmitter may use these subcarriers to transmit spinal symbols of a spinal encoded transmission. More specifically, an initial transmission of the spinal encoded transmission may include a first set of spinal symbols that are distributed within the spinal encoded transmission. For this first set of spinal symbols, the transmitter may place earlier spinal symbols on subcarriers associated with a higher capacity metric. For the second set of spinal symbols, the transmitter may place later spinal symbols on the subcarriers associated with the higher capacity metric.

### FIELD OF THE DISCLOSURE

Aspects of the present disclosure generally relate to wireless communication and specifically relate to techniques, apparatuses, and methods associated with spinal coding based on channel capacity.

### BACKGROUND

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, and/or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, and/or radio frequency (RF) sensing, among other examples. As the demand for connectivity continues to increase, further improvements in NR may be implemented, and other RATs, such as 6G and beyond, may be introduced to enable new applications and facilitate new use cases.

In a wireless communication system, the transmission of information is said to occur through a communication channel, referred to simply as a “channel.” A transmitted signal (x) may experience a channel effect (often denoted h, where h is a channel matrix that represents the channel effect). At a receiver, a received signal may include the transmitted signal (x) as transformed by the channel effect, plus noise (z, sometimes denoted n):

$$y = hx + z$$

Thus, the transmitted signal is transformed and corrupted by both the channel's inherent characteristics and by random noise sources, leading to information loss or distortion.

Channel coding addresses these challenges. Channel coding includes techniques for improving the reliability of communications via a wireless channel. For example, some forms of channel coding may provide structured redundancy and error-correction mechanisms. Some channel coding approaches include block codes and convolutional codes, which provide for the addition of redundant bits to an input communication or signal.

### SUMMARY

In some aspects, techniques described herein relate to a method of wireless communication by a transmitting device, including identifying a set of subcarriers, of a plurality of subcarriers, with a capacity metric that satisfies a threshold. The method may include encoding a plurality of segments of data, using a spinal coding technique, to generate a plurality of spinal symbols having a first ordering. The method may include performing a first transmission of a first set of spinal symbols of the plurality of spinal symbols, wherein at least a subset of the first set of spinal symbols are on a first set of subcarriers of the set of subcarriers according to the first ordering. The method may include performing a second transmission of a second set of spinal symbols of the plurality of spinal symbols different than the first set of spinal symbols, wherein the second set of spinal symbols are on a second set of subcarriers of the set of subcarriers, and wherein the second set of spinal symbols is selected from the plurality of spinal symbols according to a second ordering that is a reverse of the first ordering.

In some aspects, techniques described herein relate to a method of wireless communication by a receiving device, including identifying a set of subcarriers, of a plurality of subcarriers, with a capacity metric that satisfies a threshold. The method may include receiving, on a first set of subcarriers of the set of subcarriers, a first transmission. The method may include decoding, according to a first mapping between the first set of subcarriers and a first set of spinal symbols of a plurality of spinal symbols, the first transmission to obtain the first set of spinal symbols. The method may include receiving, on a second set of subcarriers, a second transmission; and decoding, according to a second mapping between the second set of subcarriers and a second set of spinal symbols of the plurality of spinal symbols, the second transmission to obtain the second set of spinal symbols.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, this specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network.

FIG. 2 is a diagram illustrating an example disaggregated network entity architecture.

FIG. 3 depicts aspects of network entities and a user equipment (UE).

FIG. 4 is a diagram illustrating an example associated with encoding of spinal codes in accordance with the present disclosure.

FIG. 5 is a diagram illustrating an example associated with a puncturing scheme for spinal codes in accordance with the present disclosure.

FIG. 6 is a diagram illustrating an example of decoding of a spinal encoded transmission based on a decoding process.

FIG. 7 provides an example of a puncturing scheme for a spinal encoded transmission.

FIG. 8 is a diagram illustrating an example of channel capacity on a plurality of frequencies.

FIG. 9 is a diagram illustrating an example of a mapping between the channel capacities of example and the transmissions of example.

FIG. 10 is a diagram illustrating an example of signaling for channel-aware spinal coded transmission.

FIG. 11 shows a method for wireless communication by a transmitting device.

FIG. 12 shows a method for wireless communication by a receiving device.

FIG. 13 depicts aspects of an example communications device configured for wireless communications.

FIG. 14 depicts aspects of an example communications device configured for wireless communications.

### DETAILED DESCRIPTION

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

Channel coding includes techniques for improving the reliability of communications via a wireless channel. For example, some forms of channel coding may provide structured redundancy and error-correction mechanisms. Some channel coding approaches include block codes and convolutional codes, which provide for the addition of redundant bits to an input communication or signal. Such forms of channel coding may use a coding rate (sometimes referred to as a code rate). The coding rate is defined as the ratio of original information bits to total transmitted bits. A coding rate of R=k/n indicates that k original information bits are mapped to n total transmitted bits, with the additional bits serving as error-correction information.

Other forms of channel coding use rateless codes. Unlike channel codes that use a fixed coding rate, rateless codes may dynamically generate additional redundant information that can be continuously decoded until sufficient data is received for accurate reconstruction. This approach allows receivers to recover transmitted information without being constrained by a predetermined, fixed encoding scheme. Some rateless codes are non-binary codes, which provide for jointly encoding and modulating a communication for transmission.

A spinal code can be used to implement rateless coding. Spinal codes can handle time-varying channel conditions without explicit bit rate selection. Spinal codes involve transmission at a higher rate than a channel can sustain, followed by iterative retransmission of information bits to lower the effective rate until a decoding success occurs (for example, until the receiver transmits an acknowledgment (ACK) or a negative acknowledgment (NACK)). More specifically, the transmitter may perform the encoding once, and the channel rate may be changed based at least in part on the total quantity of channel uses (for example, a total quantity of times a communication channel is utilized to transmit information, which, in some examples, corresponds to a total quantity of resource elements). By contrast, in other coding schemes, changing the channel rate is considered to be part of re-encoding the data.

In spinal coding, input data is broken down into multiple segments, and each of these segments is sequentially processed to generate a respective spinal symbol. These spinal symbols are mapped (for example, converted or treated as) to modulation symbols and transmitted. A receiver may obtain the modulation symbols from the transmission, and may attempt to decode the spinal symbols of the modulation symbols. For example, the receiver may use a decoding tree with a bubble decoder for this process. In practice, the performance of the bubble decoder is limited in the interest of managing computational complexity. For example, a fixed quantity of nodes of the decoding tree (comprising fewer nodes than are included in each stage of the decoding tree) are retained at each stage of the decoding tree, and remaining nodes are not retained, which is referred to as pruning the remaining nodes.

Some approaches for transmitting spinal symbols provide for the transmission of selected spinal symbols in order to improve the likelihood of successful decoding of each transmission. For example, a first transmission may include a first subset of a plurality of spinal symbols, and a second transmission may include a second subset of the plurality of spinal symbols. These different subsets of spinal symbols may not be consecutive in the sequence of generated spinal symbols, and thus the corresponding decoding tree's stages for these different subsets of spinal symbols may not be consecutive to one another.

As mentioned, the channel over which encoded communications are transmitted varies over time, in the spatial domain, and/or in the frequency domain. For example, a first frequency resource (such as a first subcarrier) may have a first channel capacity and a second frequency resource may have a second channel capacity different than the first channel capacity. Further, the first channel capacity and the second channel capacity may change over time. This means that data transmitted on the first subcarrier may have a different likelihood of successful reception in comparison to data transmitted on the second subcarrier, and these likelihoods may vary over time.

Due to the nature of bubble decoding, the number of hypotheses for the information of a spinal encoded transmission increases drastically (for example, exponentially) as the separation between spinal symbols input to the bubble decoder increases. For example, non-consecutive spinal symbols are associated with a higher number of hypotheses, and thus higher computational burden, than consecutive spinal symbols. This increase in the number of hypotheses leads to increased likelihood that the bubble decoder will fail to decode the spinal encoded transmission, since the receiver is likely to discard one or more paths of the decoding tree that correspond to a correct decoding.

In spinal coding, the initial transmission (at the higher rate than the channel can sustain) can be implemented in a variety of fashions. In one approach, alternating spinal symbols of the spinal encoded transmission (for example, every other symbol) are transmitted first, and then subsets of remaining spinal symbols of the spinal encoded transmission are transmitted in subsequent transmissions. The initial transmission improves efficiency and reliability of decoding, since separation between spinal symbols is reduced and previously calculated sub-trees of the decoding tree can be reused for decoding of the subsequent transmissions. Furthermore, the transmission of different subsets of remaining spinal symbols in each subsequent transmission reduces the number of total channel uses relative to transmitting the entire spinal coded transmission at once.

However, channel conditions can vary at the granularity of a subcarrier or a resource block, and different spinal symbols, even within an initial transmission or a subsequent transmission, may be transmitted on different subcarriers or resource blocks. Thus, a situation can arise where multiple consecutive spinal symbols are not received at the receiver due to a combination of puncturing and poor channel performance. In this situation, decoding of the communication is likely to fail, since the separation between received spinal symbols creates decoding complexity. Further, in some situations, a spinal symbol closer to the beginning of the decoding process may be of higher importance to successful decoding (such as in an initial transmission), but in other situations, a spinal symbol closer to the end of the decoding process may be of higher importance (such as in a retransmission). Thus, an approach that indiscriminately prioritizes a certain set or ordering of spinal symbols in all situations may provide suboptimal performance improvements.

Aspects of the present disclosure relate generally to implementing spinal coding, in conjunction with multiple transmissions (such as a multiple incremental redundancy scheme (MIRS)), in a channel-aware fashion. For example, a wireless communication device referred to herein as a transmitter may identify, based on channel conditions at the wireless communication device, a set of subcarriers (or other frequency resources) associated with a capacity metric that satisfies a threshold. For example, these subcarriers may have higher than a threshold capacity metric, indicating a higher level of reliability. By using the threshold, the transmitter and receiver can come to a common understanding of which subcarriers may be used to transmit a spinal encoded transmission, and may thereby conserve processing resources that would otherwise be used to measure or signal information regarding all subcarriers irrespective of whether such subcarriers satisfy the threshold. However, it should be noted that aspects described herein may be implemented without a threshold, such as by ordering a full set of subcarriers according to a capacity metric.

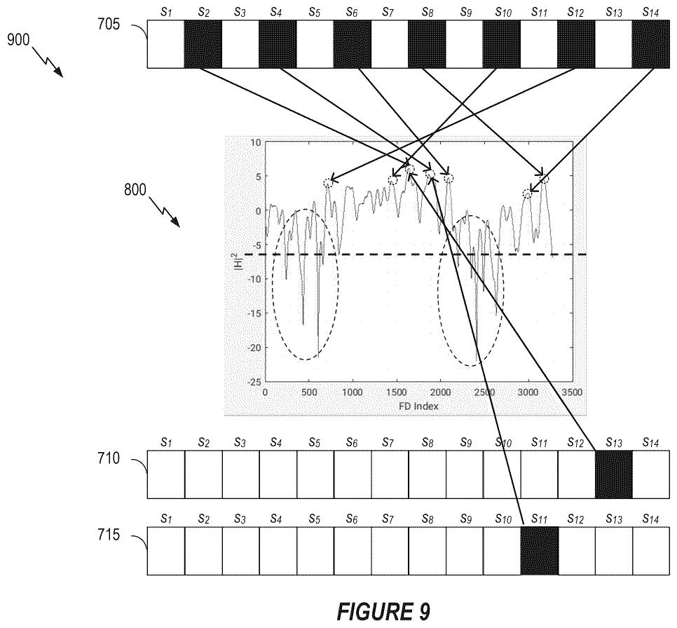

The transmitter may use these subcarriers to transmit spinal symbols of a spinal encoded transmission. More specifically, an initial transmission of the spinal encoded transmission may include a first set of spinal symbols that are distributed within the spinal encoded transmission. For this first set of spinal symbols, the transmitter may place earlier spinal symbols (that is, spinal symbols that are processed earlier in the decoding process or that have a larger number of subsequent/dependent spinal symbols) on subcarriers associated with a higher capacity metric. For the second set of spinal symbols, the transmitter may place later spinal symbols (that is, spinal symbols that are processed later in the decoding process or that have a smaller number of subsequent/dependent spinal symbols) on the subcarriers associated with the higher capacity metric. In some examples, channel nulls (or low-capacity frequencies) are spread uniformly among the initial transmission (as illustrated, for example, in connection with FIG. 9), which decreases the probability of consecutive nulls at a receiver.

Aspects of the present disclosure may be used to realize one or more of the following potential advantages. In some aspects, by transmitting the first set of spinal symbols with earlier spinal symbols on subcarriers associated with a higher capacity metric, earlier stages of the bubble decoding process are protected, which allows reuse of calculated values of the bubble decoding process for subsequent transmissions of the spinal code, thereby reducing latency and complexity. Furthermore, by transmitting the second set of spinal symbols with later spinal symbols on subcarriers associated with a higher capacity metric, the likelihood of successful reception of these later spinal symbols is increased, which reduces the number of expected retransmissions, thereby reducing latency. Furthermore, decoding performance is increased by using these higher-capacity subcarriers.

As described above, wireless communication systems may be deployed to provide various services, which may involve carrying or supporting voice, text, other messaging, video, data, and/or other traffic. Some wireless communications systems may employ multiple-access radio access technologies (RATs). The multiple-access RATs may be capable of supporting communication with multiple wireless communication devices by sharing the available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G New Radio (NR) is part of a continuous mobile broadband evolution promulgated by the Third Generation Partnership Project (3GPP). 5G NR may support enhanced mobile broadband (eMBB) access, Internet of Things (IOT) networks or reduced capability (RedCap) device deployments, ultra-reliable low-latency communication (URLLC) applications, and/or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

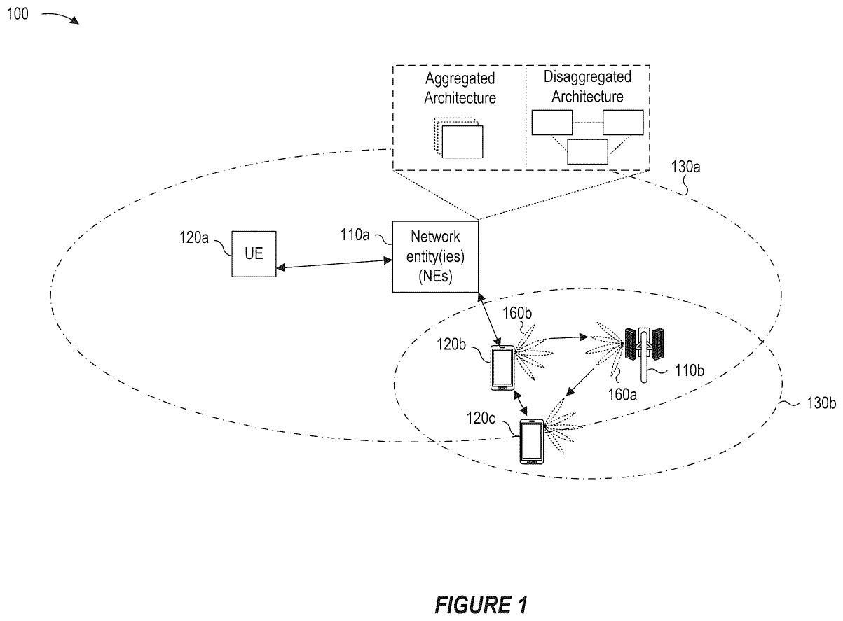

FIG. 1 is a diagram illustrating an example of a wireless communication network 100. The wireless communication network 100 may be or may include elements of a 5G network or a 6G network, among other examples. The wireless communication network 100 may include multiple network entities 110. For example, in FIG. 1, the wireless communication network 100 includes a network entity (NE) 110a and a network entity 110b. The network entities 110 may support communications with multiple UEs 120. For example, in FIG. 1, the network entities 110 support communication with a UE 120a, a UE 120b, and a UE 120c. In some examples, a UE 120 may also communicate with other UEs 120 and a network entity 110 may communicate with a core network and with other network entities 110.

The network entities 110 and the UEs 120 of the wireless communication network 100 may communicate using the electromagnetic spectrum, which may be subdivided into various licensed or unlicensed operating bands, frequency ranges, component carriers, or channels that define associated frequencies available for communications. In some examples, each of the network entities 110 and the UEs 120 may communicate using one or multiple component carriers in one or more operating bands or ranges. Typically, various operating bands are defined as frequency range designations FR1 (410 MHz through 7.125 GHZ), FR2 (24.25 GHz through 52.6 GHz), FR3 (7.125 GHz through 24.25 GHZ), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHZ, FR1 is often referred to (interchangeably) as a “sub-6 GHz” band in some documents and articles. Similarly, FR2 is often referred to (interchangeably) as a “millimeter wave” band in some documents and articles. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to mid-band frequencies or to frequencies that are within FR2, FR4, FR4-a or FR4-1, FR5, and/or the EHF band. Higher frequency bands may extend 5G NR operation, 6G operation, and/or other RATs beyond 52.6 GHz.

A network entity 110 may be, may include, or may also be referred to as an NR network entity, a 5G network entity, a 6G network entity, a Node B, a gNB, an access point (AP), a transmission reception point (TRP), a network entity, a network element, a network equipment, and/or another type of device, component, or system included in a RAN. In various deployments, a network entity 110 may be implemented as a single physical node (for example, a single physical structure) or may be implemented as two or more physical nodes (for example, two or more distinct physical structures). For example, a network entity 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network entity 110 may be an aggregated network entity having an aggregated architecture, meaning that the network entity 110 may implement a full radio protocol stack that is physically and logically integrated within a single physical structure in the wireless communication network 100. For example, an aggregated network entity 110 may consist of a single standalone base station or a single TRP that operates with a full radio protocol stack to enable or facilitate communication between a UE 120 and a core network of the wireless communication network 100.

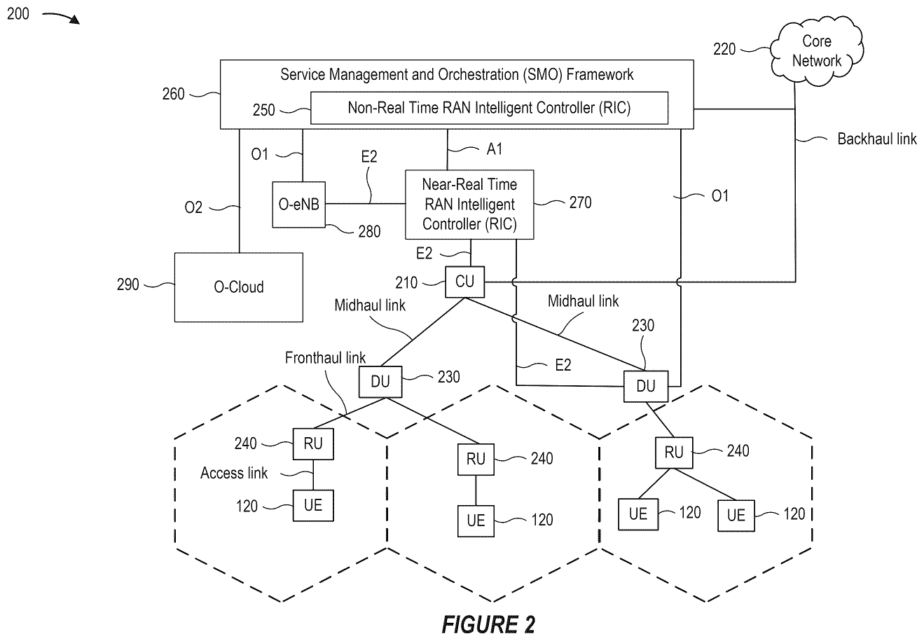

Alternatively, and as also shown, a network entity 110 may be a disaggregated network entity (sometimes referred to as a disaggregated base station), having a disaggregated architecture, meaning that the network entity 110 may operate with a radio protocol stack that is physically distributed and/or logically distributed among two or more nodes in the same geographic location or in different geographic locations. An example disaggregated network entity architecture is described in more detail below with reference to FIG. 2. In some deployments, disaggregated network entities 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network entities 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, and/or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network entity 110 may include a combination of one or more CUs, one or more DUs, and/or one or more RUs. In some examples, a CU, a DU, and/or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network entities 110 (for example, a base station, an RU, or a TRP) may provide communication coverage for a particular geographic area. The term “cell” can refer to a coverage area of a network entity 110 or to a network entity 110 itself, depending on the context in which the term is used. A network entity 110 may support one or more cells (for example, each cell may support communication within an angular (for example, 60 degree) range around the network entity). In some examples, a network entity 110 may provide communication coverage for a macro cell, a pico cell, a femto cell, or another type of cell. A macro cell may cover a relatively large geographic area (for example, several kilometers in radius) and may allow unrestricted access by UEs 120 with associated service subscriptions. A pico cell may cover a relatively small geographic area and may also allow unrestricted access by UEs 120 with associated service subscriptions. A femto cell may cover a relatively small geographic area (for example, a home) and may allow restricted access by UEs 120 having association with the femto cell (for example, UEs 120 in a closed subscriber group (CSG)). In some examples, a cell may not necessarily be stationary. For example, the geographic area of the cell may move according to the location of an associated mobile network entity 110 (for example, a train, a satellite, an unmanned aerial vehicle, or an NTN network entity).

The wireless communication network 100 may be a heterogeneous network that includes network entities 110 of different types, such as macro network entities, pico network entities, femto network entities, relay network entities, aggregated network entities, and/or disaggregated network entities, among other examples. Various different types of network entities 110 may generally transmit at different power levels, serve different coverage areas (for example, a cell 130a and a cell 130b), and/or have different impacts on interference in the wireless communication network 100 than other types of network entities 110.

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, smart jewelry, a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network entity, and/or any other suitable device or function that may communicate via a wireless medium.

In some examples, a network entity 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network entity 110 to a UE 120, and “uplink” (or “UL”) refers to a communication direction from a UE 120 to a network entity 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

In some examples, a UE 120 and a network entity 110 may perform MIMO communication. MIMO communication generally refers to transmitting or receiving multiple signals (such as multiple layers or multiple data streams) simultaneously over the same time and frequency resources. A network entity 110 or a UE 120 may communicate using single-user MIMO or multi-user MIMO (MU-MIMO), the latter of which being used by a network entity 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network entity 110 may generate one or more beams 160a, and a UE 120 may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network entity 110 or a UE 120 may implement massive MIMO, which may be associated with an increased (for example, “massive”) quantity of antennas at the network entity 110 or at the UE 120, such as in a network implementing mmWave technology, which enables more precise beamforming or reduced interference. In some examples, the wireless communication network 100 may implement multi-TRP (mTRP) operation (including redundant transmission or reception on multiple TRPs) or non-coherent joint transmission (NC-JT).

The network entity 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network entity 110 transmitting signals (for example, SSBs or other signals) via respective beams (for example, of the beams 160 of the network entity 110) and the UE 120 receiving and measuring the signal(s) via respective beams of multiple beams (for example, from the beams 160 of the UE 120) to identify a best beam (or beam pair) for communication between the UE 120 and the network entity 110. A beam refinement operation may involve a first device (for example, the UE 120 or the network entity 110) transmitting signal(s) via a subset of beams (for example, identified based on, or otherwise associated with, measurements reported as part of one or more other beam management operations). A second device (for example, the network entity 110 or the UE 120) may receive the signal(s) via a single beam (for example, to identify the best beam for communication from the subset of beams). The beam(s) may be identified or defined via one or more spatial parameters, such as a transmission configuration indicator (TCI) state or a quasi co-location (QCL) parameter, among other examples.

FIG. 2 is a diagram illustrating an example disaggregated network entity architecture 200. One or more components of the example disaggregated network entity architecture 200 may be, may include, or may be included in one or more network entities (such one or more network entities 110). The disaggregated network entity architecture 200 may include a CU 210 that can communicate directly with a core network 220 via a backhaul link, or that can communicate indirectly with the core network 220 via one or more disaggregated control units, such as a Non-RT RAN intelligent controller (RIC) 250 associated with a Service Management and Orchestration (SMO) Framework 260 and/or a Near-RT RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network entity architecture 200, including the CUs 210, the DUs 230, the RUs 240, the Near-RT RICs 270, the Non-RT RICs 250, and the SMO Framework 260, may include one or more interfaces or may be coupled with one or more interfaces for receiving or transmitting signals, such as data or information, via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, and/or a Near-RT RIC 270. In some aspects, the SMO Framework 260 may communicate with a hardware aspect of a 4G RAN, a 5G NR RAN, and/or a 6G RAN, such as an open eNB (O-eNB) 280, via an O1 interface. Additionally or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, artificial intelligence or machine learning (AI/ML) workflows including model training and updates, and/or policy-based guidance of applications and/or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, and/or an O-eNB with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

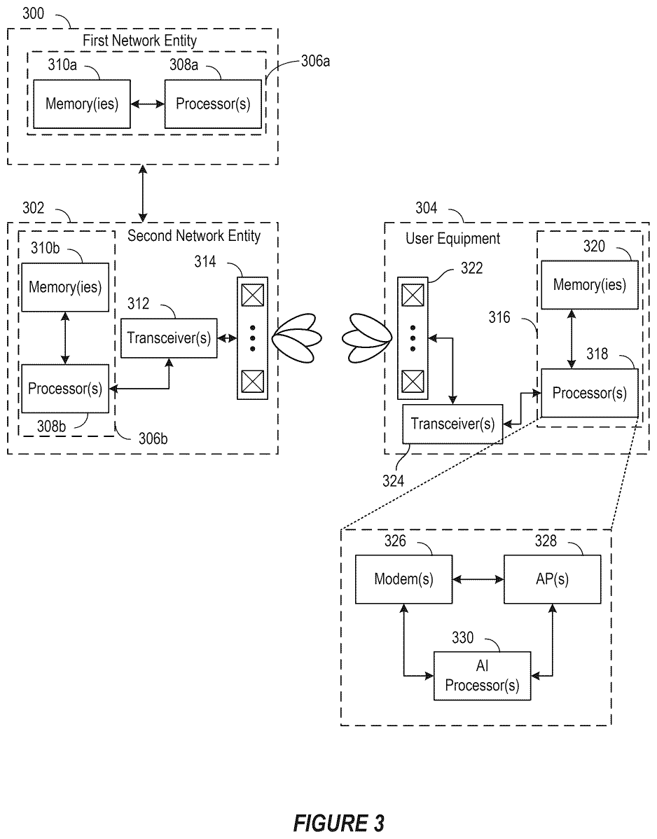

FIG. 3 depicts aspects of network entities 300 and 302 and a UE 304.

FIG. 3 includes a first network entity 300 and a second network entity 302. In some examples, first network entity 300 may be an example of a CU 210 or a DU 230. In some examples, second network entity 302 may be an example of a DU 230 or an RU 240. First network entity 300 and second network entity 302 may communicate with one another via a communications link, such as a midhaul link. In some examples, first network entity 300 and second network entity 302 may be implemented at a same BS (for example, network entity 110). For example, first network entity 300 and second network entity 302 may be co-located. In some other examples, first network entity 300 may be implemented separately from second network entity 302. For example, first network entity 300 may be implemented as a function (for example, one or more processes) running on a server, such as in a cloud (for example, a public or private cloud). As another example, first network entity 300 may be implemented as a virtual computing instance (for example, virtual machine or container) or as a physical server.

First network entity 300 and second network entity 302 each include a processing system 306, illustrated as “processing system 306a” at first network entity 300 and “processing system 306b” at second network entity 302. For example, first network entity 300 and second network entity 302 may include one or more chips, system-on-chips (SoCs), system-in-packages (SiPs), chipsets, packages, or devices that individually or collectively constitute or comprise a processing system 306. A processing system 306 includes one or more processors 308 (illustrated as “processor(s) 308a” and “processor(s) 308b”) and one or more memories 310 (illustrated as “memory(ies) 310a” and “memory(ies) 310b”) coupled to the one or more processors 308. The one or more processors 308 may include one or multiple processors, microprocessors, processing units (such as central processing units (CPUs), graphics processing units (GPUs), neural processing units (NPUs) (also referred to as neural network processors or deep learning processors (DLPs)) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

In some aspects, the processing system 306 may perform processing (such as digital signal processing) of data, control information, or signals received or transmitted by a network entity. For example, the processing system 306 may include a coder, a decoder, a multiplexer, a demultiplexer, a transmit MIMO processor, a transmit processor, a receive processor, a receive MIMO detector, an automatic gain control component, or the like.

The one or more memories 310 may include one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). The one or more memories 310 may store data and program code for first network entity 300 and/or second network entity 302.

As further shown, second network entity 302 includes one or more transceivers 312 (illustrated as “transceiver(s) 312”). The one or more transceivers 312 may perform processing related to implementing physical layer (for example, radio, air interface) communication with other devices such as UE 304. The one or more transceivers 312 may include one or more radio frequency (RF) components, such as an RF transceiver, a front-end module (for example, an RF front-end (RFFE)), or the like. For example, the one or more transceivers 312 may include a transmit path (also referred to as a transmit chain), a receive path (also referred to as a receive chain), and/or an interface with one or more antennas 314.

The one or more antennas 314 may perform wireless transmission and reception of signals. The one or more antennas 314 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3. The term “antenna module” may refer to circuitry including one or more antennas as well as one or more other components (such as filters, amplifiers, or processors) associated with integrating the antenna module into a wireless communication device such as the network entity 300 or 302 or the UE 304.

UE 304 may be an example of UE 120. As shown, UE 304 includes a processing system 316. For example, UE 304 may include one or more chips, SoCs, SiPs, chipsets, packages, or devices that individually or collectively constitute or comprise a processing system 316. A processing system 316 includes one or more processors 318, and one or more memories 320 coupled to the one or more processors 318. Further, UE 304 includes one or more antennas 322, one or more transceivers 324, and/or other components that enable wireless transmission and reception of data.

The one or more processors 318 may include one or multiple processors, microprocessors, processing units (such as CPUs, GPUs, NPUs (also referred to as neural network processors or DLPs) and/or DSPs), processing blocks, ASICs, PLDs (such as FPGAs), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. In some aspects, the processing system 316 may perform processing (such as digital signal processing) of data, control information, or signals received or transmitted by a network entity. For example, the processing system 316 may include a coder, a decoder, a multiplexer, a demultiplexer, a transmit MIMO processor, a transmit processor, a receive processor, a receive MIMO detector, an automatic gain control component, or the like.

As shown, in some examples, the one or more processors 318 may include one or more modems 326, one or more application processors (APs) 328, one or more AI processors 330, a combination thereof, and/or another form of processor.

The one or more modems 326 may include a digital signal processor that converts information into a waveform for analog signal transmission (for example, via modulation) and/or converts the waveform of a received signal into information (for example, via demodulation). The one or more modems 326 may process information or waveforms in connection with signal transmission or reception. For example, the one or more modems 326 may include a coder, a decoder, a multiplexer, a demultiplexer, a transmit MIMO processor, a transmit processor, a receive processor, a receive MIMO detector, an automatic gain control component, or the like.

The one or more APs 328 may perform processing relating to an operating system and/or a higher layer application of the UE 304. For example, the one or more APs 328 may provide a higher-level operating system (HLOS), software, audio or video processing, graphics processing, or the like. In some examples, the one or more APs 328 may be a data source (for example, for transmissions) or a data sink (for example, for receptions).

The one or more transceivers 324 may perform processing related to implementing physical layer (for example, radio, air interface) communication with other devices such as other UEs 304 or second network entity 302. The one or more transceivers 324 may include one or more RF components, such as an RF transceiver, a front-end module (for example, an RFFE), or the like. For example, the one or more transceivers 324 may include a transmit path (also referred to as a transmit chain), a receive path (also referred to as a receive chain), and/or an interface with one or more antennas 322.

The one or more antennas 322 may perform wireless transmission and reception of signals. The one or more antennas 322 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

For an example downlink transmission by second network entity 302, the processing system 306 (for example, a transmit processor) may receive data and/or control information. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

The processing system 306 (for example, a transmit processor) may process (for example, encode and symbol map) the data and control information to obtain data symbols and control symbols, respectively. The processing system 306 may also generate reference symbols, such as for the primary synchronization signal (PSS), secondary synchronization signal (SSS), PBCH demodulation reference signal (DMRS), or channel state information reference signal (CSI-RS).

The processing system 306 (for example, a TX MIMO processor) may perform spatial processing (for example, precoding) on the data symbols, the control symbols, and/or the reference symbols, if applicable, and may provide output symbol streams to one or more modulators of the processing system 306. The one or more modulators may process one or more respective output symbol streams to obtain an output sample stream. The one or more transceivers 312 may process (for example, convert to analog, amplify, filter, and upconvert) the output sample stream to obtain a downlink signal. Second network entity 302 may transmit the downlink signal via the one or more antennas 314.

In order to receive the downlink transmission at UE 304 (or a sidelink transmission from another UE), the one or more antennas 322 may receive the downlink signal and may provide received signals to the one or more transceivers 324. The one or more transceivers 324 may condition (for example, filter, amplify, downconvert, and digitize) the received signals to obtain input samples. The one or more transceivers 324 and/or the processing system 316 may further process the input samples to obtain received symbols.

The processing system 316 (for example, modem 326, an RX MIMO detector) may obtain the received symbols, perform MIMO detection on the received symbols if applicable, and provide detected symbols. The processing system 316 (for example, a modem 326, a receive processor) may process (for example, de-interleave and decode) the detected symbols. The processing system 316 may provide decoded data for the UE 304 (for example, to an AP 328) and/or decoded control information (for example, to a controller/processor of the processing system 316).

For an example uplink transmission or a sidelink transmission from UE 304, the processing system 316 (for example, modem 326, a transmit processor) may receive and process data and/or control information to obtain a set of symbols for transmission. The data may be for the physical uplink shared channel (PUSCH), and may be received from a data source such as the AP 328. The control information may be for the physical uplink control channel (PUCCH), and may be received, for example, from a controller/processor of the processing system 316. The processing system 316 (for example, a modem 326, the transmit processor) may also generate reference symbols for a reference signal (for example, for a sounding reference signal (SRS), a demodulation reference signal, a phase tracking reference signal, or the like). In some examples, the symbols and/or reference signals may be precoded by the processing system 316 (for example, modem 326, a TX MIMO processor), further processed by the one or more transceivers 324 (for example, for single carrier frequency division multiplexing (SC-FDM)), and transmitted to second network entity 302.

At second network entity 302, the uplink signals from UE 304 may be received by the one or more antennas 314, conditioned by the one or more transceivers 312 (for example, filtered, amplified, downconverted, and digitized), detected (for example, by the processing system 306b such as a modem and/or an RX MIMO detector), and further processed by the processing system 306b (for example, a modem and/or a receive processor) to obtain decoded data and control information sent by UE 304. The processing system 306b may provide the decoded data and the decoded control information (such as to a controller/processor of the processing system 306b, an AP, first network entity 300, or another entity).

In various aspects, a wireless communication device, such as first network entity 300, second network entity 302, network entity 110, UE 120, or UE 304, may be described as sending, transmitting, obtaining, or receiving various types of data associated with the methods described herein. In these contexts, “transmitting” or “sending” may refer to various mechanisms of outputting data, such as outputting data from a processing system, one or more memories, one or more transceivers, one or more antennas, and/or other aspects described herein. For example, “sending” or “transmitting” by a device may include sending (such as wirelessly, via a wired connection, or both) to a recipient directly or via another device. As another example, “sending” or “transmitting” may include sending internally to a device (such as the UE 304, first network entity 300, or second network entity 302) by a process to memory. “Receiving” or “obtaining” may refer to various mechanisms of obtaining data, such as obtaining data from the processing system, one or more memories, one or more transceivers, one or more antennas, and/or other aspects described herein. For example, “receiving” or “obtaining” by a device may include obtaining (such as wirelessly, via a wired connection, or both) from a recipient directly or via another device. As another example, “receiving” or “obtaining” may include obtaining internally to a device (such as the UE 304, first network entity 300, or second network entity 302) by a process from memory. As used herein, “communicating” by a device may include sending, obtaining, receiving, and/or transmitting a communication. “Communicating” can refer to communication with another device or internal communication of the device.

In various aspects, the processing system 306 or the processing system 316 may include one or more AI processors (such as AI processor 330 of the processing system 316). Some aspects and techniques as described herein may be implemented, at least in part, using an AI program (for example, referred to herein as an “AI/ML model”), such as a program that includes a machine learning (ML) model and/or an artificial neural network (ANN) model. The AI/ML model may be deployed at a device (for example, a network entity 300 or 302, a UE 304, an AI/ML server). For example, the AI/ML model may be deployed at a UE 304 (for example, the processing system 316), a network entity 110 (for example, the processing system 306), one or more servers, and/or one or more components of a cloud computing network, among other examples. In some examples, the AI/ML model (or an instance of the AI/ML model) may be deployed at multiple devices (for example, a first portion of the AI/ML model may be deployed at a UE 304 and a second portion of the AI/ML model may be deployed at a network entity 300 or 302). In other examples, a first AI/ML model may be deployed at a UE 304 and a second AI/ML model may be deployed at a network entity 300 or 302. The AI/ML model(s) may be configured to enhance various aspects of wireless communication. For example, the AI/ML model(s) may be trained to identify patterns or relationships in data corresponding to the wireless communication, a device, and/or an air interface, among other examples. The AI/ML model(s) may support operational decisions relating to one or more aspects associated with wireless communications devices, networks, or services.

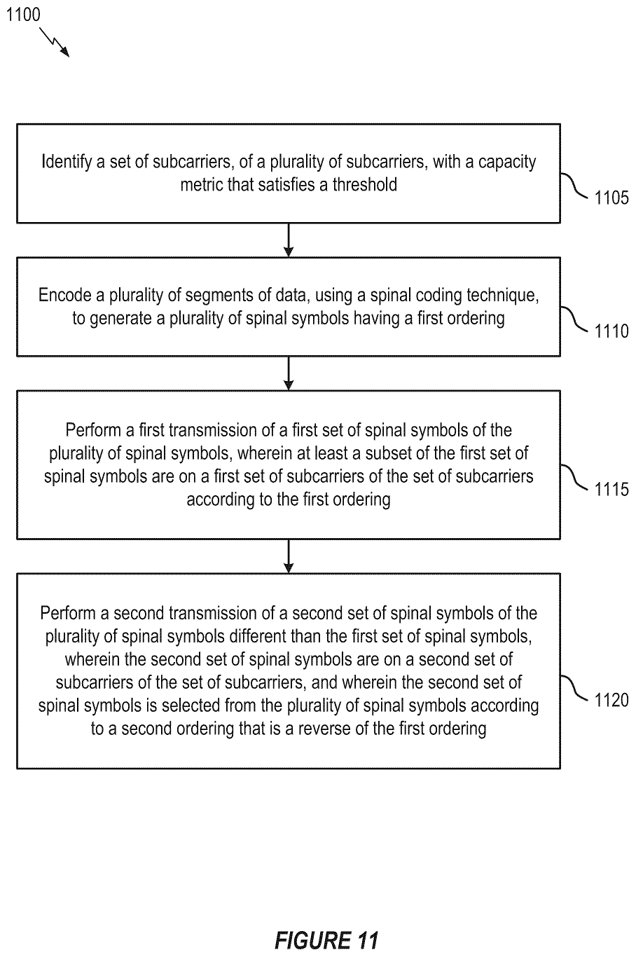

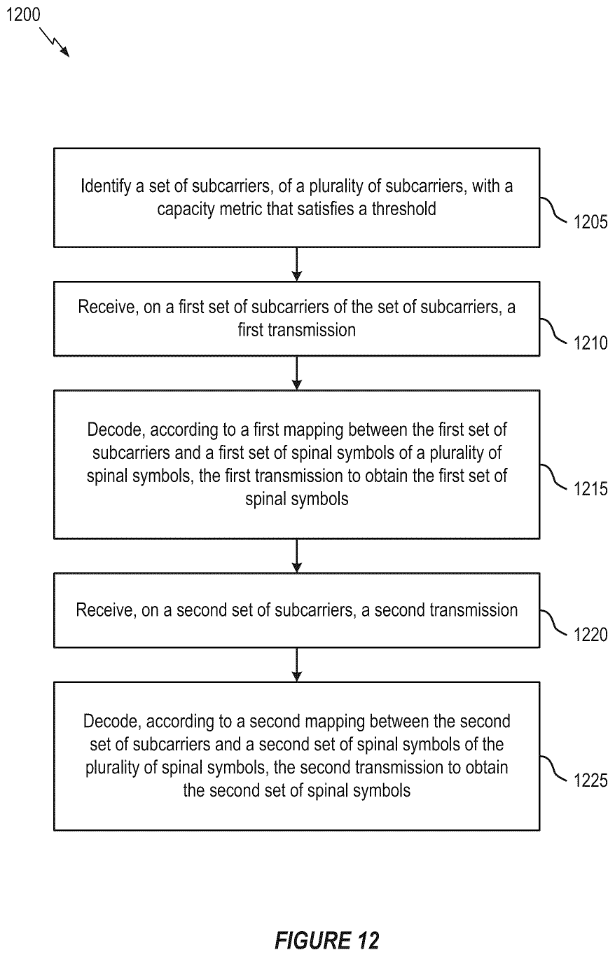

The network entity 110, the UE 120, the CU 210, the DU 230, the RU 240, the network entity 300 or 302, the processing system 306, the UE 304, the processing system 316, or any other component(s) of FIGS. 1, 2, and/or 3 may implement one or more techniques or perform one or more operations associated with channel-aware spinal code transmission, as described in more detail elsewhere herein. For example, the network entity 110, network entity 300, or network entity 302 (collectively, “network entity 110/300/302”), the UE 120 or UE 304 (collectively, “UE 120/304”), the CU 210, the DU 230, the RU 240, the processing system 306, or the processing system 316 may perform or direct operations of, for example, method 1100 of FIG. 11, method 1200 of FIG. 12, or other processes as described herein (alone or in conjunction with one or more other processors). Memory of the network entity 110/300/302 may store data and program code (or instructions) for the network entity 110/300/302, the CU 210, the DU 230, or the RU 240. In some examples, the memory of the network entity 110/300/302 may store data relating to a UE 120/304, such as RRC state information or a UE context. Memory of the UE 120/304 may store data and program code (or instructions) for the UE 120/304, such as context information. In some examples, the memory of the UE 120/304 or the memory of the network entity 110/300/302 may include a non-transitory computer-readable medium storing a set of instructions for wireless communication. For example, the set of instructions, when executed by one or more processors (for example, the one or more processors 308 or the one or more processors 318) of the network entity 110/300/302, the UE 120/304, the CU 210, the DU 230, or the RU 240, may cause the one or more processors to perform method 1100 of FIG. 11, method 1200 of FIG. 12, or other processes as described herein. In some examples, executing instructions may include running the instructions, converting the instructions, compiling the instructions, and/or interpreting the instructions, among other examples.

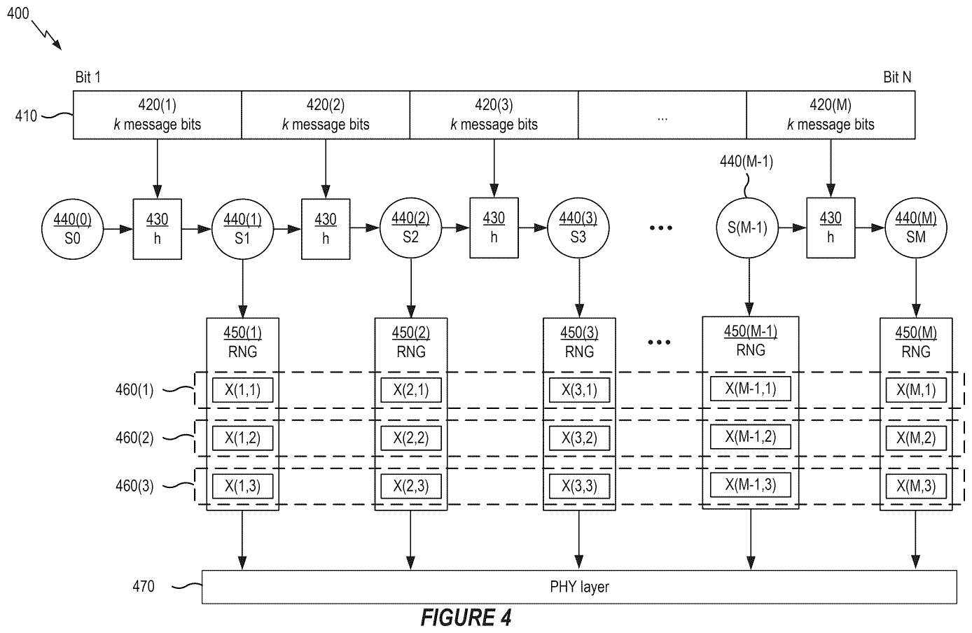

FIG. 4 is a diagram illustrating an example 400 associated with encoding of spinal codes in accordance with the present disclosure. Other transmission schemes may involve different encoding of spinal codes.

As shown, a transmitting device may break up an input message 410 of data into segments (or groups, chunks, or the like) of message bits 420(1)-420(M). The message may have a total of N bits, and each of the segments of message bits 420(1)-420(M) may have a total of k bits. Thus, the total quantity of the segments of message bits 420(1)-420(M) may be N/k (for example, M=N/k). The transmitting device may sequentially apply, to the segments of message bits 420(1)-420(M), a hash function 430 (“h”). The hash function 430 may be designed such that a difference between two input messages in at least one bit results in a different coded sequence after the at least one bit, which may provide resilience to noise and bit errors.

The hash function 430 may also operate on v-bit states 440(0)-440(M−1), where v may be any suitable number (for example, 32). Thus, the hash function 430 may take two inputs: the blocks of message bits 420(1)-420(M) and the v-bit states 440(0)-440(M−1). The hash function 430 may output the v-bit states 440(1)-440(M) based at least in part on the blocks of message bits 420(1)-420(M) and the v-bit states 440(0)-440(M−1). In some examples, h:{0,1}^{v}×{0,1}^{v}→{0,1}^{v}. In some examples, sᵢ=h(sᵢ₋₁,m̅ᵢ), where sᵢ is an i^{th} v-bit state 440(i) and m̅ᵢ is an i^{th} block of message bits 420(i).

For example, initially, the hash function 430 may take, as input, the block of message bits 420(1) and the v-bit state 440(0). The hash function 430 and the v-bit state 440(0) may be known to the transmitting device and the receiving device. In some examples, the v-bit state 440(0) may be zero. The hash function 430 may output the v-bit state 440(1), take, as input, the block of message bits 420(2) and the v-bit state 440(1), and output the v-bit state 440(2). This process may continue until the hash function 430 outputs the v-bit state 440(M). In this manner, the transmitting device may generate a “spine” of v bit states 440(1)-440(M) by sequentially hashing together the blocks of message bits 420(1)-420(M) from the input message 410 without adding redundancy bits.

The hash function 430 may provide the v-bit states 440(1)-440(M) as input (for example, seeds) to random number generators (RNGs) 450(1)-450(M). In some examples, the RNGs 450(1)-450(M) may be known to the transmitting device and the receiving device. The RNGs 450(1)-450(M) may generate sequences of random c-bit binary numbers: RNG: {0,1}^{v}× [symbol] →{0,1}^{c}. Thus, the transmitting device may randomly map the blocks of message bits 420(1)-420(M) to respective c-bit binary numbers. In some examples, a c-bit binary number may be a binary word that includes c bits. In some examples, the c-bit binary numbers may map to output IQ constellation symbols. For example, the transmitting device may use a mapping function to randomly select the output IQ constellation symbols. In this manner, the transmitting device may produce a sequence of coded bits and symbol for transmission. In some examples, the total quantity of the blocks of message bits 420(1)-420(M) may be equal to the total quantity of transmitted symbols. While some aspects described herein are described with regard to a quadrature amplitude modulation (QAM) constellation, aspects described herein can be implemented for any form of constellation (for example, a non-square constellation, a Gaussian distributed constellation, or the like).

In some examples, each of the RNGs 450(1)-450(M) may generate multiple sequences of random c-bit binary numbers. For example, in a first pass 460(1), the RNGs 450(1)-450(M) may generate first sequences of random c-bit binary numbers. The transmitting device may, using the mapping function, convert the random c-bit binary numbers into first output IQ constellation symbols. The transmitting device may transmit, at a PHY layer 470, one or more samples corresponding to the first output IQ constellation symbols, and if the receiving device responds with a NACK, then the RNGs 450(1)-450(M) may, in a second pass 460(2), generate second sequences of random c-bit binary numbers. A sample may occupy a time window (for example, a slot) during which a transmitted signal has a given amplitude and/or phase corresponding to a given symbol (for example, a sample may encode a symbol). The transmitting device may, using the mapping function, convert the second sequences of random c-bit binary numbers into second output IQ constellation symbols. The transmitting device may transmit, at the PHY layer 470, one or more samples corresponding to the second output IQ constellation symbols, and if the receiving device responds with a NACK, then the RNGs 450(1)-450(M) may, in a third pass 460(3), generate third sequences of random c-bit binary numbers. The transmitting device may, using the mapping function, convert the third sequences of random c-bit binary numbers into third output IQ constellation symbols. The transmitting device may transmit, at the PHY layer 470, one or more samples corresponding to the third output IQ constellation symbols. It should be noted that, in some aspects described herein, only a subset of spinal symbols (and thus sequences of c-bit binary numbers) are transmitted in a given transmission. Furthermore, the IQ constellation symbols (or other actually transmitted symbols) may be referred to herein as spinal symbols, and may be referred to as being derived from spinal values or spines. This process may continue until the transmitting device receives an ACK from the receiving device or a timeout occurs. As used in FIG. 4, the notation “X (Y,Z)” refers to a Z^{th} pass performed by a Y^{th} RNG. In some examples, the transmitting device may transmit one symbol per v-bit state per pass; thus, if the receiving device takes l passes to decode the input message 410, then the effective rate is

$$\frac{k}{l}$$

bits per channel use, where k is the maximum rate.

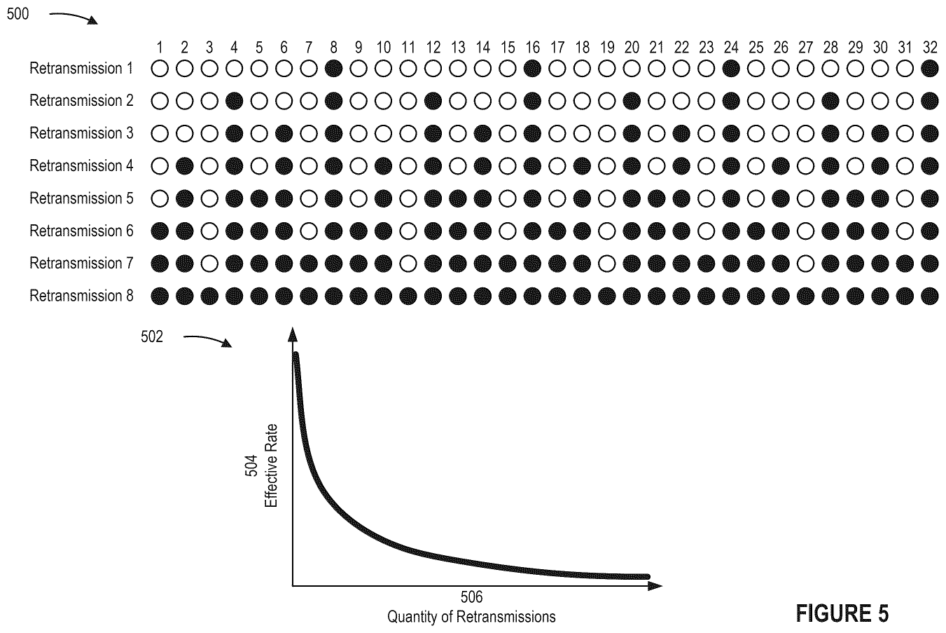

The receiving device (for example, decoder) may sequentially process the received samples until the input message 410 is successfully decoded or a timeout occurs. If the timeout occurs, then the transmitting device may proceed to a subsequent input message. This may be more readily understood with reference to FIG. 5.

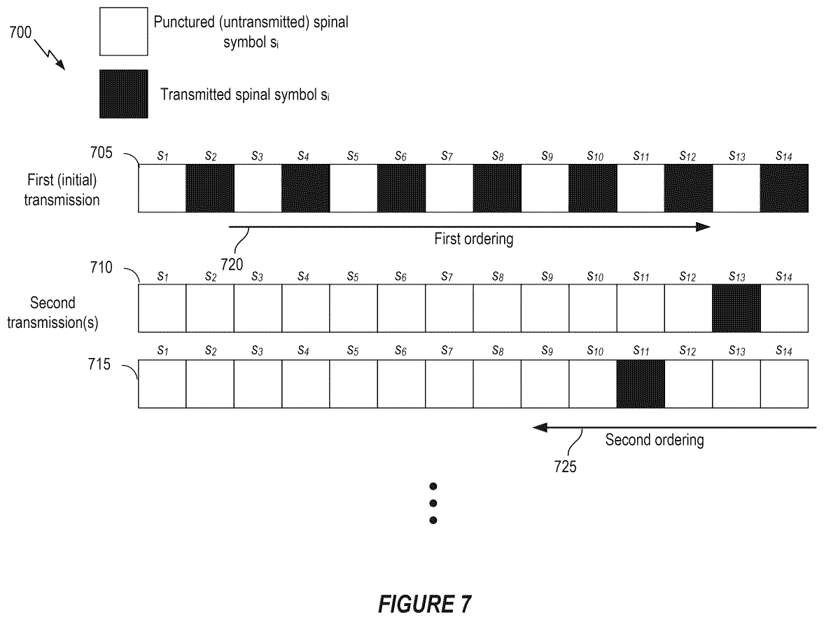

FIG. 5 is a diagram illustrating an example 500 associated with a puncturing scheme for spinal codes in accordance with the present disclosure. Another example of a puncturing scheme is provided with respect to FIG. 7.

In the example 500, a transmitting device may transmit spinal symbols to a receiving device using a quantity of retransmissions (sometimes referred to as a quantity of subpasses), indexed in FIG. 5 as retransmission 1 through retransmission 8 (but which may include more or fewer retransmissions in other examples). In each retransmission, the transmitting device transmits symbols for spine values marked by black circles, while grey circles indicate symbols that have already been transmitted (for example, in a previous retransmission). A quantity of transmitted symbols per retransmission may dictate a rate granularity for the spinal code.

More particularly, in an example in which 256 message bits are to be transmitted (for example, N=256), with each segment of message bits (corresponding to each circle in FIG. 5) including eight bits (for example, k=8), the spinal code may be associated with 32 spines (for example, quantity of spines=N/k=32, as described above in connection with FIG. 4). In such an example, a quantity (for example, less than all) of the spinal codes may be transmitted in each retransmission. More particularly, in the first retransmission, the spinal symbols associated with spines indexed 8, 16, 24, and 32 may be transmitted, shown using black circles in connection with the row corresponding to retransmission 1. In the second retransmission, the spinal symbols associated with spines indexed 5, 12, 20, and 28 may be transmitted, shown using black circles in connection with the row corresponding to retransmission 2. Moreover, because the spinal symbols associated with spines indexed 8, 16, 24, and 32 may have previously been transmitted at this point in time (for example, in retransmission 1), those spinal symbols are shown using grey circles in retransmission 2. The transmitting device may continue to transmit spinal symbols in this manner until the message is successfully decoded by the receiving device or until all spinal symbols have been transmitted (for example, as shown in connection with retransmission 8).

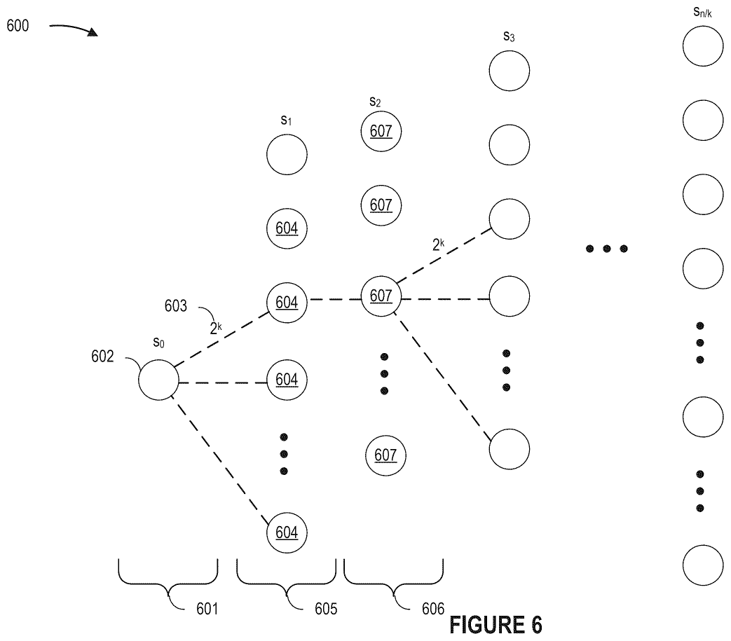

In this regard, the receiving device may attempt to decode the message after each retransmission. In some examples, a receiving device may decode the received spinal symbols using a bubble decoder and/or a bubble decoding algorithm, which is described in connection with FIG. 6. After at least the initial transmission, the receiving device may successfully decode the message.

Once the message is successfully decoded, the receiving device may transmit an acknowledgement message to the transmitting device, and the transmitting device may forgo transmitting any remaining retransmissions. In that regard, in some examples the spinal code may be considered “rateless,” because a coding rate of the spinal code may not be set and/or may vary based on channel conditions, among other examples. For example, as shown in the plot 502, which includes an effective coding rate axis 504 and a quantity of retransmissions axis 506, an effective coding rate may decrease as a quantity of retransmissions used to transmit a message increases. For example, returning to the example described above, the spinal code may start a rate of 8 bits per channel use and may decrease in a manner consistent with the plot 502 as more retransmissions are used, with the total quantity of transmitted symbols per retransmission (for example, four in the above-described example 500) dictating the effective rate granularity. In some examples, using a spinal code as a rateless code may enable use of the spinal code even in the absence of utilizing CSI-RSs or similar mechanisms for determining optimal transmission schemes (for example, optimal modulation and coding schemes (MCSs), among other examples). In some other examples, a spinal code may be associated with a fixed rate (for example, the rate of the spinal code may be determined and/or fixed when encoding data), in a similar manner to low-density parity check (LDPC) codes and/or polar codes, among other examples. For example, a spinal code encoder may limit a quantity of spinal symbols generated and/or a transmitting device may transmit a fixed quantity of spinal symbols in a channel, thereby setting a fixed rate for the spinal code. Additionally, or alternatively, spinal codes may be used in a similar manner as LDPC codes and/or polar codes, however, an MCS may be used to generate an equivalent puncturing scheme for the spinal code, among other examples.

FIG. 6 is a diagram illustrating an example 600 of decoding of a spinal encoded transmission based on a decoding process. A decoding process may be referred to as a decoding tree. Example 600 is an example of decoding using a bubble decoding algorithm. However, some of the description provided in connection to FIG. 6 relates to a maximum likelihood decoder without using bubble decoding, such that the benefits of bubble decoding are more readily understood.

Consider an n-bit message, denoted M′, that has been encoded via spinal coding according to an encoder function x̅(M′) (such as the encoder described in connection with FIG. 4). Thus, there are 2ⁿ possible codewords (that is, possible values of the message) for the message. For example, an 8-bit message can have 256 possible values, each value being a different codeword.

The message is received as a series of spinal symbols subject to some channel noise. For example, a receiving device (such as UE 120, network entity 110, or the like) may receive a signal, which may be considered a vector of observations denoted y (recall that y denotes the received signal in the classical channel model described elsewhere herein). The vector y is subject to channel noise before reception by the receiving device.

One approach for decoding the n-bit message is to use a maximum likelihood (ML) decoder without bubble decoding. Generally, an ML decoder calculates, per codeword, a distance ∥y̅−x̅(M′)∥ between generated symbols (generated by x̅(M′)) and actual received noisy symbols (received as y) using a cost function denoted Formula 1:

$$\hat{M} ∈ {arg min}_{{M}^{′} ∈ {\{ 0 , 1 \}}^{n}} {‖ \overline{y} - \overline{x} ( {M}^{′} ) ‖}^{2} \qquad ( 1 )$$

In this approach, the decoded message, \hat{M} (where the “hat” symbol denotes an observed message), is the codeword that minimizes the distance over all received spinal symbols. If some spinal symbols are punctured for the transmission, these spinal symbols are not considered in the above calculation. Note that the puncturing scheme used to puncture these spinal symbols is known to the receiving device and a transmitting device. If multiple subpasses are performed, the receiving device may combine (such as average or sum) the metric of each spinal symbol between passes. This approach provides decoding of spinal encoded transmissions, but with some computational complexity.

The sequentially-hashed nature of spinal coding enables some complexity reduction by using a bubble decoding algorithm to decode the spinal encoded transmission. The bubble decoding algorithm for spinal codes involves navigating a decoding tree (referred to herein as a decoding process) of potential messages. The decoding tree includes n/k stages, where k is a number of bits per segment of the message, where each segment corresponds to a spinal symbol sᵢ.

A first stage 601 of the decoding tree includes only a single leaf 602, since the spinal encoder is initialized with a known or predefined state so (shown by reference number 440(0) of FIG. 4). As shown at 603, there are 2^{k} paths per stage and per node, since there are k bits per block and thus 2^{k} possible next spinal symbols proceeding from a given spinal symbol. The number of paths per stage and per node is referred to as the width of the decoding tree. Paths are indicated by a dashed line, and not all paths and nodes are shown for simplicity.

The spinal encoder applies the hash function sequentially, so input messages with a common prefix will also have a common spine prefix. Furthermore, the spinal symbols, produced by the random number generator from the spine values used to generate the common spine prefix, will be identical to one another. This structure can be exploited using bubble decoding. For example, the observed signal y̅ can be broken down into sub-vectors

$${\overline{y}}_{l} … {\overline{y}}_{\frac{n}{k}} .$$

These sub-vectors represent the spinal values sᵢ of the correct message (as well as for x̅(M′)). The bubble decoder can use a cost function referred to as Formula 2:

$${‖ \overline{y} - \overline{x} ( {M}^{′} ) ‖}^{2} = {\sum }_{i = 1}^{\frac{n}{k}} {‖ {\overline{y}}_{l} - {\overline{x}}_{i} ( {s}_{i}^{′} ) ‖}^{2} \qquad ( 2 )$$

For this cost function, the sum only needs to be computed once for all messages that share the same spine value sᵢ. Thus, the decoding tree of example 600 can be used to perform tree decoding, with a root of the tree decoding at the leaf 602 corresponding to s₀. Summing costs (determined using the cost function denoted Formula 2 above) on the path from the leaf 602 to a given node provides a path cost of the node. The bubble decoder may identify a leaf (for example, node) with a lowest path cost, and may return a decoded message corresponding to the series of spinal values (or spinal symbols) corresponding to leaves (or nodes) on the path to and including the leaf. Additionally or alternatively, the bubble decoder can identify a set of candidate leaves (or nodes), and can perform a cyclic redundancy check on all remaining leaves/spinal values. “Leaf” and “node” may be used interchangeably.

Efficiency of bubble decoding can further be improved by implementing a pruned breadth-first search approach. This approach uses two parameters: a depth, d, and a beam width, B. In this approach, a “beam” of B potential leaves is maintained at each stage. If at a given stage, more than B potential leaves satisfy a threshold for the path cost, the receiving device may proceed to the next stage (spine value) with only the B potential leaves possessing lowest costs. Remaining leaves other than the B potential leaves are discarded at each stage. For each of the B potential leaves, a partial decoding tree of depth d is maintained. Thus, the beam width is analogous to a list size in a list decoder. The beam width may be constrained by or based on available memory of the receiving device. Thus, it can be seen that a situation can arise in which a potential leaf that is in the leaf path of the actual message may be discarded, if other leaves happen to have lower costs according to Formula 2.

For example, the receiving device may receive a signal and may select B=4 potential leaves 604 for a second stage 605. For each of these potential leaves 604, the receiving device may maintain a partial decoding tree at the depth d. At a third stage 606, the receiving device may calculate path costs for all potential hypotheses (all potential leaves of the third stage 606) based on the potential leaves 604 and the partial decoding tree. The receiving device may identify potential leaves 607 and may maintain a partial decoding tree at the depth d. This process may continue until the receiving device has identified a single hypothesis (potential leaf) or checks remaining hypotheses according to a cyclic redundancy check.

If a given spinal symbol (corresponding to a given stage) is punctured and thus not received at the receiving device, the receiving device may not evaluate path costs for potential leaves in the given stage. This increases the likelihood that a potential leaf corresponding to an actual message is discarded. Thus, a situation where multiple consecutive spinal symbols are punctured, are not received at the receiving device, or are subject to particularly poor channel conditions, is likely to lead to a failure to decode the spinal encoded message.

FIG. 7 provides an example 700 of a puncturing scheme for a spinal encoded transmission. Example 700 illustrates a plurality of spinal symbols (in example 700, 14 spinal symbols). In an initial transmission 705, a first set of spinal symbols comprising even-indexed spinal symbols (such as s₂, s₄, and so on) are transmitted and remaining spinal symbols of the plurality of spinal symbols are punctured. In some examples, the first set of spinal symbols may comprise another arrangement of spinal symbols, such as odd-indexed spinal symbols (such as s₁, s₃, and so on).

After the initial transmission 705, subsequent transmissions 710 and 715 include different spinal symbols of the remaining spinal symbols. For example, subsequent transmission 710 includes a highest-indexed spinal symbol of the remaining spinal symbols. Subsequent transmission 715 includes a next-highest-indexed spinal symbol of the remaining spinal symbols.

Certain aspects described herein use an ordering. A first ordering is illustrated at 720. In the first ordering, an action is performed using increasing spinal symbol indexes sᵢ. For example, if the first ordering is used to determine which spinal symbol is mapped to a highest-capacity subcarrier, then a lowest-indexed spinal symbol may be mapped first, followed by a second-lowest-indexed spinal symbol of remaining spinal symbols other than the lowest-indexed spinal symbol, and so on. A second ordering is illustrated at 725. The second ordering is a reverse of the first ordering. In the second ordering, an action is performed using decreasing spinal symbol indexes sᵢ. For example, if the second ordering is used to determine which spinal symbol is mapped to a highest-capacity subcarrier, then a highest-indexed spinal symbol may be mapped first, followed by a second-highest-indexed spinal symbol of remaining spinal symbols other than the highest-indexed spinal symbol, and so on. A spinal symbol with index s₂ has a higher index than a spinal symbol with index s₁.

The approach shown in example 700 may reduce decoding complexity. For example, as noted elsewhere herein, a gap in received spinal symbols (in which a single spinal symbol or multiple consecutive spinal symbols are not successfully received at the receiving device) may decrease the likelihood of successful decoding and increase computational costs. This effect may be proportional to the number of consecutive spinal symbols that are not successfully received. By providing an initial transmission 705 in which every other spinal symbol is transmitted, the distance in terms of spinal symbols/stages of the initial transmission 705 relative to spinal symbols/stages of subsequent transmissions is minimized, since the spinal symbols/stages of the subsequent transmissions are adjacent to a spinal symbol that was already transmitted in the initial transmission 705 (thereby reducing the likelihood of discarding an actually correct path and reducing recalculation costs relative to a situation in which multiple consecutive spinal symbols are untransmitted.

Furthermore, when a spinal symbol that occurs at a later stage in the decoding tree is transmitted in a subsequent transmission, less recalculation of path costs is involved than when a spinal symbol that occurs at an earlier stage in the decoding tree is transmitted in the subsequent transmission. For example, if a retransmission occurs at a certain stage (corresponding to a certain spine or spinal symbol), a previously calculated sub-tree can be used for stages occurring earlier in the decoding tree than the certain stage, which saves complexity. Upon receiving the spinal symbol, the receiving device may recalculate path costs starting at the spinal symbol (and corresponding stage) and through the end of the decoding tree, which means that a spinal symbol toward the end of the decoding tree (as is transmitted in the subsequent transmission 715) is less computationally costly to incorporate into the decoding tree than a spinal symbol toward the beginning of the decoding tree.

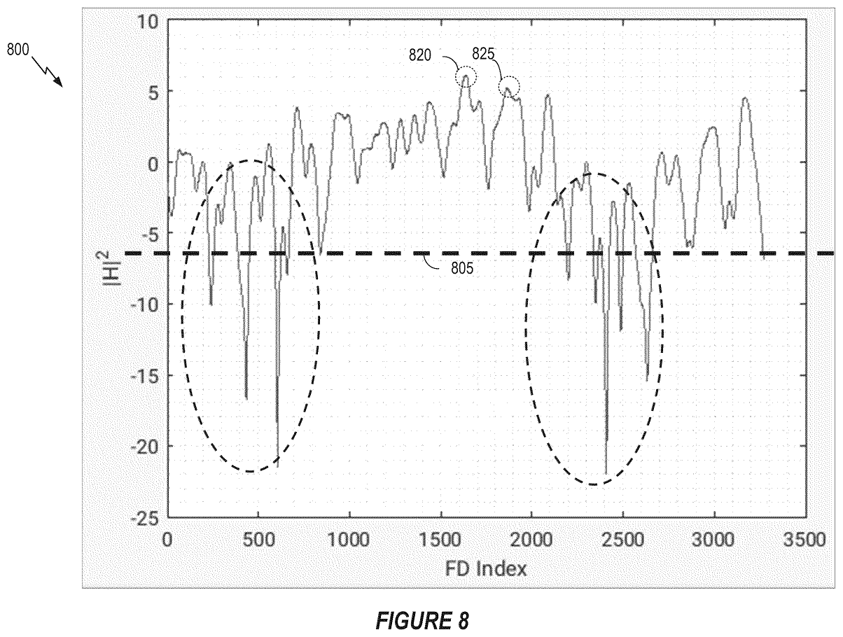

FIG. 8 is a diagram illustrating an example 800 of channel power on a plurality of frequencies. The vertical axis represents a channel power (which may include a measurement of Shannon's capacity as log₂ (1+SNR_subcarrier) and the horizontal axis represents a plurality of frequencies, such as subcarriers or resource blocks or the like. A higher point on the vertical axis is associated with a higher capacity metric. For example, a subcarrier with a capacity metric above a threshold 805 may provide a higher channel capacity in terms of signal-to-noise ratio (SNR), throughput, reference signal received power (RSRP), or another metric than a subcarrier with a capacity metric below the threshold 805. Aspects described herein with regard to one type of frequency resource (such as subcarriers) can be readily applied with regard to other types of frequency resources (such as resource blocks). A frequency resource with a higher capacity metric may be referred to as a higher-capacity frequency resource and a frequency resource with a lower capacity metric may be referred to as a lower-capacity frequency resource. A capacity metric may be defined at the granularity of a subcarrier, a resource block, or another frequency resource.

Some aspects described herein relate to mapping spinal symbols to frequency resources, such as subcarriers, that satisfy the threshold 805. The threshold 805 can be signaled via any suitable form of signaling, such as radio resource control (RRC) signaling, downlink control information (DCI), medium access control (MAC) signaling, or the like.

The capacity metric may be identifiable at a transmitting device (such as UE 120, UE 304, network entity 110, first network entity 300, or second network entity 302) and at a receiving device (such as UE 120, UE 304, network entity 110, first network entity 300, or second network entity 302). For example, the transmitting device and the receiving device may have common information regarding the capacity metrics of example 800. This may be based on channel reciprocity. For example, the transmitting device may determine the capacity metric for transmission based on measuring a received signal at the transmitting device (which may be transmitted by the receiving device). The transmitting device may report the capacity metric to the receiving device. Additionally, or alternatively, the receiving device may determine the capacity metric based on a signal received at the receiving device. Thus, a transmitting device or receiving device may determine the capacity metric of example 800 based on local measurements, measurement reporting, or a combination thereof.

Examples of frequency resources that fail to satisfy the threshold 805 are shown at 810 and 815. In some aspects, the transmitting device prioritizes mapping of certain spinal symbols to certain frequency resources (such as subcarriers) that satisfy the threshold 805 over the frequency resources that fail to satisfy the threshold 805. In some aspects, the transmitting device orders frequency resources according to a capacity metric of each frequency resource. For example, a frequency resource 820 with a highest channel capacity may be assigned a first frequency index f₀, a frequency resource 825 with a second-highest channel capacity may be assigned a second frequency index f₁, and so on. These frequency resources may be mapped to a transmission according to their channel capacities.

In some aspects, the transmitting device and the receiving device may communicate according to a mapping of spinal symbols to frequency resources according to an ordering. Notably, this ordering can be different for a first transmission (such as initial transmission 705) than for a retransmission (such as a subsequent transmission 710 or 715).

For example, the transmitting device may map spinal symbols of an initial transmission to frequency resources according to a first ordering. In such examples, and using the notation of f₀ for a highest-capacity frequency resource and sᵢ for a lowest-indexed spinal symbol (corresponding to an earliest stage of the decoding tree) with the transmitted spinal symbols s₂, s₄, . . . s₁₄ of the initial transmission 705), the transmitting device may map s₂ to f₀, s₄ to f₁, and so on. The receiving device may be configured with or determine this mapping. For example, the transmitting device may signal the mapping (or the ordering of frequency resources) to the receiving device via RRC signaling, MAC signaling, or DCI. As another example, the receiving device may determine the mapping based on capacity metrics (which may be measured by the receiving device or signaled to the receiving device, directly or in the form of an ordering of frequency resources, by the transmitting device). Thus, the likelihood of successful reception of earlier spinal symbols in the decoding tree, which are beneficial for improving decoding performance and reducing computational complexity at the receiving device, is improved. If enough frequency resources satisfy the threshold 805, then the transmitting device may map an entirety of the initial transmission 705 to the frequency resources that satisfy the threshold 805. If there are insufficient frequency resources satisfying the threshold 805, then the transmitting device may use one or more resources that do not satisfy the threshold 805 for the initial transmission 705 according to the first ordering, For example, after using all frequency resources that satisfy the threshold 805, the transmitting device may map one or more spinal symbols to one or more frequency resources (such as subcarriers) that are excluded from the set of frequency resources that satisfy the threshold 805 (for example, in an order from a highest channel metric to a lowest capacity metric). In some aspects, aspects described herein may be implemented without the threshold 805. For example, the transmitting device may order a plurality of frequency resources according to capacity metric, and may map spinal symbols according to this order without filtering based on the threshold 805. The transmitting device may transmit the spinal symbols of the initial transmission according to the mapping.

Additionally or alternatively, the transmitting device may map spinal symbols of a subsequent transmission to frequency resources according to a second ordering. In such examples, and using the notation of f₀ for a highest-capacity frequency resource and s₁ for a lowest-indexed spinal symbol (corresponding to an earliest stage of the decoding tree) with the transmitted spinal symbol s₁₁ and s₁₃ of the subsequent transmission 710 and the subsequent transmission 710), the transmitting device may map s₁₃ to f₀, and may then map sᵢ to f₀ (since the subsequent transmission 710 and the subsequent transmission 715 are separate transmissions). Alternatively, the transmitting device may map s₁₃ to f₀, and may then map s₁₁ to f₁. The receiving device may be configured with or determine this mapping. For example, the transmitting device may signal the mapping (or the ordering of frequency resources) to the receiving device via RRC signaling, MAC signaling, or DCI. As another example, the receiving device may determine the mapping based on channel information (which may be measured by the receiving device or signaled to the receiving device, directly or in the form of an ordering of frequency resources, by the transmitting device). Thus, the likelihood of successful reception of later spinal symbols in the decoding tree is improved. If enough frequency resources satisfy the threshold 805, then the transmitting device may map an entirety of the subsequent transmission 710 or 715 to the frequency resources that satisfy the threshold 805. If there are insufficient frequency resources satisfying the threshold 805, then the transmitting device may use one or more resources that do not satisfy the threshold 805 for the subsequent transmission 710 or 715 according to the second ordering, for example, after using all frequency resources that satisfy the threshold 805.

Thus, the transmitting device avoids mapping spinal symbols to low-capacity frequencies, such as those shown at 810 and 815, thereby reducing the likelihood of decoder failure and improving spinal decoding performance. Furthermore, the transmitting device uses different mappings for initial transmissions and for subsequent transmissions due to challenges associated with decoding spinal coded transmissions and managing computational complexity.

FIG. 9 is a diagram illustrating an example 900 of a mapping between the channel capacities of example 800 and the transmissions of example 700. As shown, spinal symbols of the initial transmission 705 are mapped to frequency resources according to a first ordering (such as left-to-right, starting at s₂ and concluding with s₁₄), with lowest-indexed spinal symbols mapped to highest-capacity frequencies. Spinal symbols of the subsequent transmissions 710 and 715 are mapped to frequency resources according to a second ordering (such as right-to-left, starting at s₁₃ and proceeding to s₁₁), with highest-indexed spinal symbols mapped to highest-capacity frequencies. In some aspects, the highest-capacity frequencies for the subsequent transmissions are the same highest-capacity frequencies used for the initial transmission 705, as illustrated in FIG. 9. In some other aspects, the highest-capacity frequencies for the subsequent transmissions are selected from remaining frequencies other than the highest-capacity frequencies used for the initial transmission 705. While the subsequent transmissions each include a single spinal symbol, in some aspects, a subsequent transmission may include a plurality of spinal symbols, and these spinal symbols may be mapped to frequencies according to the second ordering.

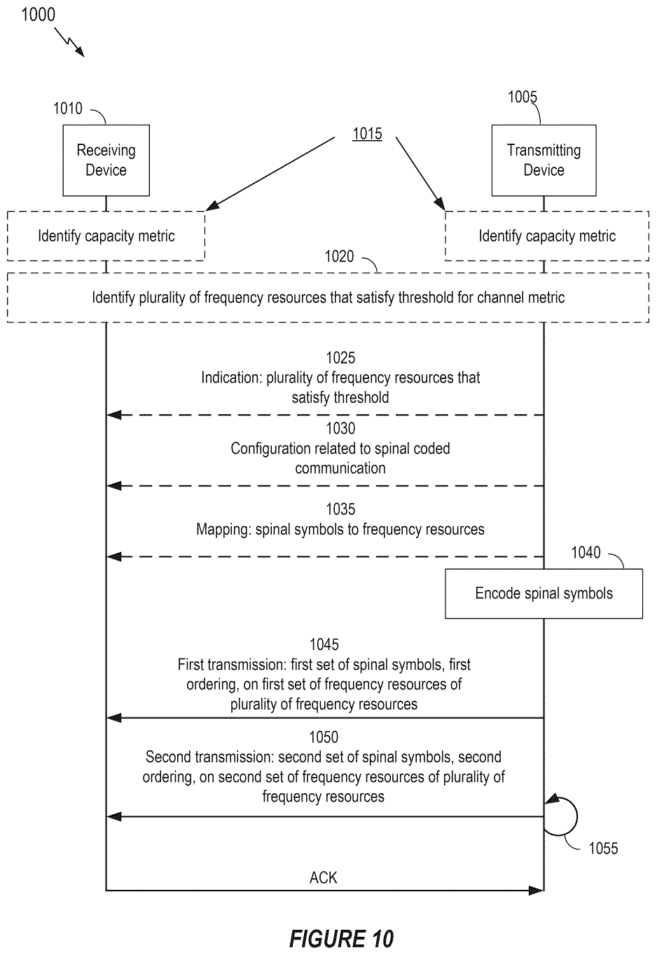

FIG. 10 is a diagram illustrating an example 1000 of signaling for channel-aware spinal coded transmission. Example 1000 includes a transmitting device 1005 (such as UE 120, UE 304, network entity 110, first network entity 300, or second network entity 302) and a receiving device 1010 (such as UE 120, UE 304, network entity 110, first network entity 300, or second network entity 302).

As shown at 1015, the transmitting device 1005 and the receiving device 1010 may identify a capacity metric. For example, one of the transmitting device 1005 or the receiving device 1010 may identify a capacity metric as described in connection with FIG. 8 (such as based on measuring a sounding reference signal), and may signal an indication of the capacity metric to the other of the transmitting device 1005 or the receiving device 1010. In some aspects, the transmitting device 1005 and the receiving device 1010 may independently measure the capacity metric. In some aspects, the transmitting device 1005 and the receiving device 1010 may have channel reciprocity, meaning that channel conditions for transmission can be inferred from channel conditions for reception (and that channel conditions for reception at the receiving device 1010 can be inferred from an uplink transmission of the receiving device 1010). In some aspects, the channel reciprocity may be based on the transmitting device 1005 and the receiving device 1010 being deployed in a time division duplexing (TDD) configuration.

As shown at 1020, one or more of the transmitting device 1005 or the receiving device 1010 may identify a plurality of frequency resources that satisfy a threshold for a channel metric. An example of the threshold is provided as the threshold 805. Additionally or alternatively, the transmitting device 1005 or the receiving device 1010 may identify a ranking of frequency resources based on their channel metrics. For example, the transmitting device 1005 or the receiving device 1010 may assign indexes f₀, f₁, and so on, to highest-capacity frequency resources, as described in connection with FIGS. 8 and 9.

As shown at 1025, the transmitting device 1005 may signal an indication of the plurality of frequency resources that satisfy the threshold to the receiving device 1010. In some aspects, the receiving device 1010 may signal an indication of the plurality of frequency resources that satisfy the threshold to the transmitting device 1005. In some aspects, the transmitting device 1005 may signal an indication of the ranking of frequency resources to the receiving device 1010, or the receiving device 1010 may signal an indication of the ranking of frequency resources to the transmitting device 1005.

As shown at 1030, in some aspects, the transmitting device 1005 may signal, to the receiving device 1010, a configuration relating to spinal coded communication. For example, the configuration may indicate a transmission scheme. The transmission scheme may indicate a distribution of spinal symbols to be transmitted in an initial transmission and/or one or more subsequent transmissions. For example, the transmission scheme may indicate indexes of spinal symbols to be transmitted in an initial transmission (such as every other spinal symbol) and to be transmitted in one or more subsequent transmission. As another example, the transmission scheme may be as illustrated in FIG. 7 for any number of spinal symbols. In some aspects, the configuration may indicate a code rate, a block size, or another parameter used for spinal coding.

As shown at 1035, in some aspects, the transmitting device 1005 may signal, to the receiving device 1010, a mapping of spinal symbols to frequency resources (for example, frequency resources or resource blocks). For example, the transmitting device 1005 may provide information that explicitly indicates a spinal symbol and a corresponding frequency resource or set of frequency resources to which the spinal symbol is mapped. In some aspects, the transmitting device 1005 may not explicitly signal the mapping. For example, the transmitting device 1005 may provide a configuration relating to spinal coded communication and information regarding a capacity metric, and the receiving device may generate the mapping using this information and configuration.

As shown at 1040, the transmitting device 1005 may encode a plurality of spinal symbols. For example, the transmitting device 1005 may obtain an input message (such as input message 410). The transmitting device 1005 may separate the input message 410 into segments of message bits (such as segments 420). The transmitting device 1005 may sequentially apply a hash function (such as hash function 430) to each segment and an input state (such as state 440) to generate a spine of values (such as a spine of states 440). The transmitting device 1005 may process the spine of values using an RNG or another form of processing to generate spinal symbols, with each spinal symbol corresponding to a respective segment 420. Each spinal symbol (corresponding to a state selected from states 440(1) to 440(M)) may be assigned a respective index 1 through M (s₁ through s_{M}). In a first ordering, the spinal symbols may be mapped in a direction of increasing indexes (from 1 toward M). In a second ordering which is the reverse of the first ordering, the spinal symbols may be mapped in a direction of decreasing indexes (from M toward 1).

As shown at 1045, the transmitting device 1005 may perform a first transmission of a first set of spinal symbols of the plurality of spinal symbols. The first transmission of the first set of spinal symbols may include, for example, the initial transmission 705. For example, the first transmission may include every other spinal symbol of the plurality of spinal symbols (such as only even-indexed spinal symbols or only odd-indexed spinal symbols). At least a subset of the first set of spinal symbols of the first transmission may be on a first set of frequency resources of the plurality of frequency resources described above. For example, the transmitting device 1005 may use frequency resources whose channel metrics satisfy the threshold, which may include up to all frequency resources of the plurality of frequency resources whose channel metrics satisfy the threshold, to transmit the first set of spinal symbols. Any remaining spinal symbols, after the first set of frequency resources are occupied by spinal symbols of the first set of spinal symbols, may be transmitted on frequency resources that do not satisfy the threshold. As described elsewhere herein, the transmitting device 1005 may map the first set of spinal symbols to frequency resources (including at least the first set of frequency resources) according to a first ordering, such that a lowest-indexed spinal symbol is mapped to a frequency resource having a highest channel metric, a second-lowest-indexed spinal symbol is mapped to a frequency resource having a second-highest channel metric, and so on, until all spinal symbols are mapped.

As shown at 1050, the transmitting device 1005 may perform a second transmission of a second set of (one or more) spinal symbols of the plurality of spinal symbols. The second transmission may include, for example, subsequent transmission 710. The second set of spinal symbols may be different from the first set of spinal symbols. For example, the second set of spinal symbols may include a highest-indexed spinal symbol of remaining spinal symbols, of the plurality of spinal symbols, other than the first set of spinal symbols. The second set of spinal symbols may be selected from the plurality of spinal symbols according to a second ordering. For example, the second ordering may indicate to first select a highest-indexed spinal symbol of remaining spinal symbols, of the plurality of spinal symbols, other than the first set of spinal symbols. Additionally or alternatively, the second set of spinal symbols may be mapped to a second set of frequency resources of the plurality of frequency resources. The second set of frequency resources may be different than the first set of frequency resources, but in some aspects may include at least one frequency resource of the first set of frequency resources. In some aspects, the second set of spinal symbols may be mapped to the second set of frequency resources according to the second ordering, such that a highest-indexed spinal symbol of the second set of spinal symbols is mapped to a frequency resource having a highest channel metric, a second-highest-indexed spinal symbol of the second set of spinal symbols is mapped to a frequency resource having a second-highest channel metric, and so on, until all spinal symbols of the second set of spinal symbols are mapped.

As shown at 1055, the transmitting device 1005 may continue to transmit spinal symbols of the plurality of spinal symbols until the transmitting device 1005 receives an acknowledgment from the receiving device 1010. For example, after performing the second transmission without receiving an acknowledgment, the transmitting device 1005 may perform a third transmission (which may be an example of the subsequent transmission 715) on one or more frequency resources of the plurality of frequency resources, for example, according to the second ordering. This may continue (with transmission of different spinal symbols of the plurality of spinal symbols) until the receiving device 1010 successfully decodes the plurality of spinal symbols and sends an acknowledgment at 1055.

The receiving device 1010 may attempt to decode the first transmission and the second transmission. For example, upon receiving the first transmission, the receiving device 1010 may use the mapping to identify an ordering of the first set of spinal symbols, and may perform bubble decoding, as described in connection with FIGS. 5 and 6, based on stages of a decoding process corresponding to the first set of spinal symbols. If decoding of the first set of spinal symbols is unsuccessful, the receiving device 1010 may not transmit an acknowledgment (or may transmit a negative acknowledgment), may receive the second transmission, and may use the mapping to identify a stage of the decoding process corresponding to the second set of spinal symbols. The receiving device 1010 may attempt decoding using a result of attempting to decode the first set of spinal symbols and using the received signal of the second set of spinal symbols. This may continue iteratively until the receiving device 1010 successfully decodes the plurality of spinal symbols and sends an acknowledgment at 1055.

FIG. 11 shows a method 1100 for wireless communication by a transmitting device, such as network entity 110 of FIG. 1, a first network entity 300 or second network entity 302 of FIG. 3, a disaggregated base station as discussed with respect to FIG. 2, or transmitting device 1005.

Method 1100 begins at block 1105 with identifying a set of subcarriers, of a plurality of subcarriers, with a capacity metric that satisfies a threshold.

Method 1100 then proceeds to block 1110 with encoding a plurality of segments of data, using a spinal coding technique, to generate a plurality of spinal symbols having a first ordering.

Method 1100 then proceeds to block 1115 with performing a first transmission of a first set of spinal symbols of the plurality of spinal symbols, wherein at least a subset of the first set of spinal symbols are on a first set of subcarriers of the set of subcarriers according to the first ordering.

Method 1100 then proceeds to block 1120 with performing a second transmission of a second set of spinal symbols of the plurality of spinal symbols different than the first set of spinal symbols, wherein the second set of spinal symbols are on a second set of subcarriers of the set of subcarriers, and wherein the second set of spinal symbols is selected from the plurality of spinal symbols according to a second ordering that is a reverse of the first ordering.

In some aspects, one or more spinal symbols of the first set of spinal symbols are on a subcarrier, of the plurality of subcarriers, excluded from the set of subcarriers.

In some aspects, the second set of spinal symbols is selected from remaining spinal symbols, of the plurality of spinal symbols, other than the first set of spinal symbols.

In some aspects, the plurality of spinal symbols have corresponding indexes that increase in accordance with the first ordering, and wherein the second set of spinal symbols are selected to have decreasing indexes of the plurality of spinal symbols.

In some aspects, the second set of spinal symbols includes a highest-indexed spinal symbol of the remaining spinal symbols other than the first set of spinal symbols.

In some aspects, the first set of subcarriers includes one or more higher-capacity subcarriers and one or more lower-capacity subcarriers, wherein a lower-indexed spinal symbol of the first set of spinal symbols is mapped to the one or more higher-capacity subcarriers and a higher-indexed spinal symbol of the first set of spinal symbols is mapped to the one or more lower-capacity subcarriers.

In some aspects, the lower-indexed spinal symbol is associated with an earlier node of a decoding process for the spinal coding technique and the higher-indexed spinal symbol is associated with a later node of the decoding process.

In some aspects, for the first transmission, remaining subcarriers of the plurality of subcarriers, other than the set of subcarriers, are mapped to untransmitted spinal symbols of the plurality of spinal symbols.

In some aspects, block 1105 includes selecting the set of subcarriers based on the capacity metric.

In some aspects, block 1105 includes receiving an indication of the set of subcarriers.

In certain aspects, method 1100 further includes transmitting an indication of the set of subcarriers.

In some aspects, the first set of subcarriers includes the second set of subcarriers.

In certain aspects, method 1100 further includes transmitting information indicating one or more of: a first mapping of the first set of spinal symbols to the first set of subcarriers, or a second mapping of the second set of spinal symbols to the second set of subcarriers.

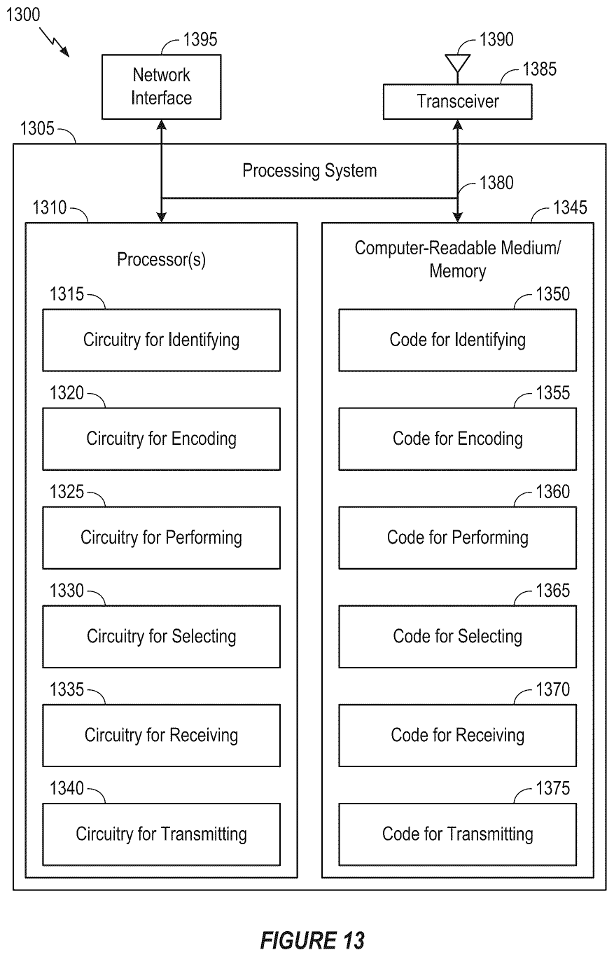

In some aspects, method 1100, or any aspect related to it, may be performed by an apparatus, such as communications device 1300 of FIG. 13, which includes various components operable, configured, or adapted to perform the method 1100. Communications device 1300 is described below in further detail.

Note that FIG. 11 is just one example of a method, and other methods including fewer, additional, or alternative operations are possible consistent with this disclosure.

### Example Operations of a User Equipment

FIG. 12 shows a method 1200 for wireless communication by a receiving device, such as UE 120 of FIG. 1, UE 304 of FIG. 3, or a receiving device 1010.

Method 1200 begins at block 1205 with identifying a set of subcarriers, of a plurality of subcarriers, with a capacity metric that satisfies a threshold.

Method 1200 then proceeds to block 1210 with receiving, on a first set of subcarriers of the set of subcarriers, a first transmission.

Method 1200 then proceeds to block 1215 with decoding, according to a first mapping between the first set of subcarriers and a first set of spinal symbols of a plurality of spinal symbols, the first transmission to obtain the first set of spinal symbols.

Method 1200 then proceeds to block 1220 with receiving, on a second set of subcarriers, a second transmission.

Method 1200 then proceeds to block 1225 with decoding, according to a second mapping between the second set of subcarriers and a second set of spinal symbols of the plurality of spinal symbols, the second transmission to obtain the second set of spinal symbols.

In some aspects, the second set of spinal symbols is selected from remaining spinal symbols other than the first set of spinal symbols.

In some aspects, the plurality of spinal symbols have corresponding indexes that increase in accordance with a first ordering, and wherein the second set of spinal symbols, according to a second ordering, have decreasing indexes of the plurality of spinal symbols.

In some aspects, the second set of spinal symbols includes a highest-indexed spinal symbol of the remaining spinal symbols other than the first set of spinal symbols.

In some aspects, the first set of subcarriers includes one or more higher-capacity subcarriers and one or more lower-capacity subcarriers, wherein a lower-indexed spinal symbol of the first set of spinal symbols is mapped to the one or more higher-capacity subcarriers and a higher-indexed spinal symbol of the first set of spinal symbols is mapped to the one or more lower-capacity subcarriers according to the first mapping.

In some aspects, the lower-indexed spinal symbol is associated with an earlier node of a decoding process for the spinal coding technique and the higher-indexed spinal symbol is associated with a later node of the decoding process.

In some aspects, for the first transmission, remaining subcarriers of the plurality of subcarriers, other than the set of subcarriers, are mapped to untransmitted spinal symbols of the plurality of spinal symbols according to the first mapping.

In some aspects, block 1205 includes selecting the set of subcarriers based on the capacity metric.

In some aspects, block 1205 includes receiving an indication of the set of subcarriers.

In some aspects, method 1200 further includes transmitting an indication of the set of subcarriers.

In some aspects, the first set of subcarriers includes the second set of subcarriers.

In some aspects, method 1200 further includes receiving information indicating the first mapping or the second mapping.

In some aspects, block 1215 includes performing a first bubble decoding operation using a decoding process, wherein the first set of spinal symbols are associated with a set of nodes of the decoding process comprising only one of: even-indexed nodes of the decoding tree, or odd-indexed nodes of the decoding tree.

In some aspects, block 1225 includes performing a second bubble decoding operation using the decoding process, wherein the second set of spinal symbols includes a spinal symbol associated with a highest-indexed node, of remaining nodes of the decoding process other than the set of nodes.

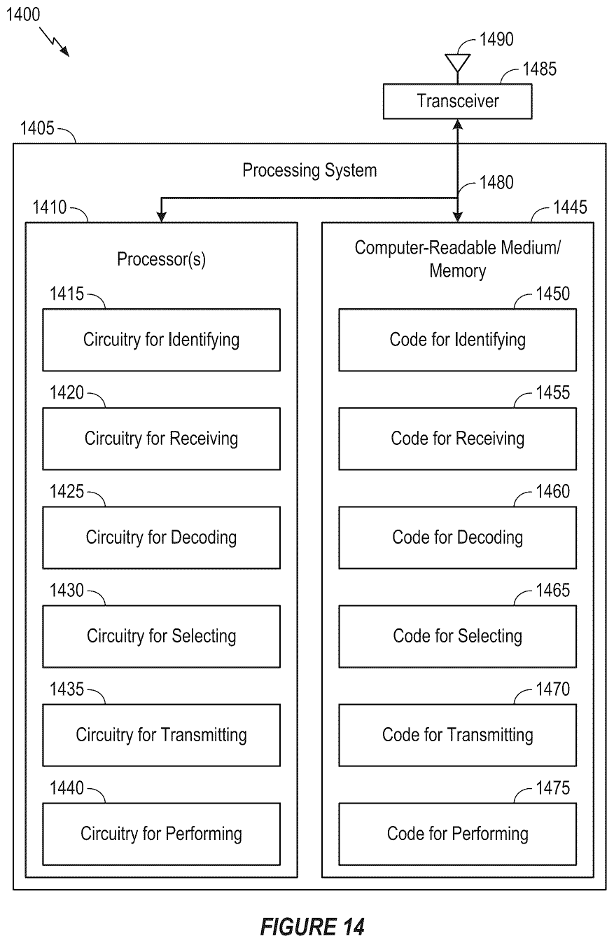

In some aspects, method 1200, or any aspect related to it, may be performed by an apparatus, such as communications device 1400 of FIG. 14, which includes various components operable, configured, or adapted to perform the method 1200. Communications device 1400 is described below in further detail.

Note that FIG. 12 is just one example of a method, and other methods including fewer, additional, or alternative operations are possible consistent with this disclosure.

### Example Communications Devices

FIG. 13 depicts aspects of an example communications device configured for wireless communications. In some aspects, communications device 1300 is a network entity, such as network entity 110 of FIG. 1, first network entity 300 or second network entity 302 of FIG. 3, or a disaggregated base station as discussed with respect to FIG. 2.

The communications device 1300 includes a processing system 1305 coupled to a transceiver 1385 (for example, a transmitter and/or a receiver) and/or a network interface 1395. The transceiver 1385 is configured to transmit and receive signals for the communications device 1300 via an antenna 1390, such as the various signals as described herein. The network interface 1395 is configured to obtain and send signals for the communications device 1300 via communications link(s), such as a backhaul link, midhaul link, and/or fronthaul link as described herein, such as with respect to FIG. 2. The processing system 1305 may be configured to perform processing functions for the communications device 1300, including processing signals received and/or to be transmitted by the communications device 1300.

The processing system 1305 includes one or more processors 1310 and a computer-readable medium/memory 1345. In various aspects, one or more processors 1310 may be representative of the one or more processors 308, as described with respect to FIG. 3. The one or more processors 1310 are coupled to the computer-readable medium/memory 1345 via a bus 1380. In certain aspects, the computer-readable medium/memory 1345 is configured to store instructions (for example, computer-executable code), including code 1350-1375, that when executed by the one or more processors 1310, cause the one or more processors 1310 to perform the method 1100 described with respect to FIG. 11, or any aspect related to it, including any operations described in relation to FIG. 11. The computer-readable medium/memory 1345 is a non-transitory computer-readable medium/memory. Note that reference to a processor of communications device 1300 performing a function may include one or more processors of communications device 1300 performing that function, such as in a distributed fashion.

In the depicted example, the computer-readable medium/memory 1345 stores code (for example, executable instructions), including code for identifying 1350, code for encoding 1355, code for performing 1360, code for selecting 1365, code for receiving 1370, and code for transmitting 1375. Processing of the code 1350-1375 may enable and cause the communications device 1300 to perform the method 1100 described with respect to FIG. 11, or any aspect related to it. For instance, in some aspects, code for identifying 1350 includes code for identifying a set of subcarriers, of a plurality of subcarriers, with a capacity metric that satisfies a threshold. In some aspects, code for encoding 1355 includes code for encoding a plurality of segments of data, using a spinal coding technique, to generate a plurality of spinal symbols having a first ordering. In some aspects, code for performing 1360 includes code for performing a first transmission of a first set of spinal symbols of the plurality of spinal symbols, wherein at least a subset of the first set of spinal symbols are on a first set of subcarriers of the set of subcarriers according to the first ordering. In some aspects, code for performing 1360 includes code for performing a second transmission of a second set of spinal symbols of the plurality of spinal symbols different than the first set of spinal symbols, wherein the second set of spinal symbols are on a second set of subcarriers of the set of subcarriers, and wherein the second set of spinal symbols is selected from the plurality of spinal symbols according to a second ordering that is a reverse of the first ordering.

The one or more processors 1310 include circuitry configured to implement (for example, execute) the code stored in the computer-readable medium/memory 1345, including circuitry for identifying 1315, circuitry for encoding 1320, circuitry for performing 1325, circuitry for selecting 1330, circuitry for receiving 1335, and circuitry for transmitting 1340. Processing with circuitry 1315-1340 may enable and cause the communications device 1300 to perform the method 1100 described with respect to FIG. 11, or any aspect related to it. For instance, in some aspects, circuitry for identifying 1315 includes circuitry for identifying a set of subcarriers, of a plurality of subcarriers, with a capacity metric that satisfies a threshold. In some aspects, circuitry for encoding 1320 includes circuitry for encoding a plurality of segments of data, using a spinal coding technique, to generate a plurality of spinal symbols having a first ordering. In some aspects, circuitry for performing 1325 includes circuitry for performing a first transmission of a first set of spinal symbols of the plurality of spinal symbols, wherein at least a subset of the first set of spinal symbols are on a first set of subcarriers of the set of subcarriers according to the first ordering. In some aspects, circuitry for performing 1325 includes circuitry for performing a second transmission of a second set of spinal symbols of the plurality of spinal symbols different than the first set of spinal symbols, wherein the second set of spinal symbols are on a second set of subcarriers of the set of subcarriers, and wherein the second set of spinal symbols is selected from the plurality of spinal symbols according to a second ordering that is a reverse of the first ordering.

Various components of the communications device 1300 may provide means for performing the method 1100 described with respect to FIG. 11, or any aspect related to it. Means for communicating, transmitting, sending or outputting for transmission may include the one or more transceivers 312, one or more antennas 314, and/or processing system 306 of the first network entity 300 or the second network entity 302 illustrated in FIG. 3, transceiver 1385, antenna 1390, and/or network interface 1395 of the communications device 1300 in FIG. 13, and/or one or more processors 1310 of the communications device 1300 in FIG. 13. Means for communicating, receiving or obtaining may include the one or more transceivers 312, one or more antennas 314, and/or processing system 306 of the first network entity 300 or the second network entity 302 illustrated in FIG. 3, transceiver 1385, antenna 1390, and/or network interface 1395 of the communications device 1300 in FIG. 13, and/or one or more processors 1310 of the communications device 1300 in FIG. 13.

FIG. 14 depicts aspects of an example communications device 1400 configured for wireless communications. In some aspects, communications device 1400 is a user equipment, such as UE 120 described above with respect to FIG. 1 or UE 304 described with respect to FIG. 3.

The communications device 1400 includes a processing system 1405 coupled to a transceiver 1485 (for example, a transmitter and/or a receiver). The transceiver 1485 is configured to transmit and receive signals for the communications device 1400 via an antenna 1490, such as the various signals as described herein. The processing system 1405 may be configured to perform processing functions for the communications device 1400, including processing signals received and/or to be transmitted by the communications device 1400.

The processing system 1405 includes one or more processors 1410 and a computer-readable medium/memory 1445. In various aspects, the one or more processors 1410 may be representative of the one or more processors 318 described with respect to FIG. 3. The one or more processors 1410 are coupled to a computer-readable medium/memory 1445 via a bus 1480. In some aspects, the computer-readable medium/memory 1445 may be representative of the one or more memories 320 described with respect to FIG. 3. The computer-readable medium/memory 1445 is a non-transitory computer-readable medium/memory. In certain aspects, the computer-readable medium/memory 1445 is configured to store instructions (for example, computer-executable code), that when executed by the one or more processors 1410, cause the one or more processors 1410 to perform the method 1200 described with respect to FIG. 12, or any aspect related to it, including any operations described in relation to FIG. 12. Note that reference to a processor performing a function of communications device 1400 may include one or more processors performing that function of communications device 1400, such as in a distributed fashion.

In the depicted example, computer-readable medium/memory 1445 stores code (for example, executable instructions), including code for identifying 1450, code for receiving 1455, code for decoding 1460, code for selecting 1465, code for transmitting 1470, and code for performing 1475. Processing of the code 1450-1475 may enable and cause the communications device 1400 to perform the method 1200 described with respect to FIG. 12, or any aspect related to it. For instance, in some aspects, code for identifying 1450 includes code for identifying a set of subcarriers, of a plurality of subcarriers, with a capacity metric that satisfies a threshold. In some aspects, code for receiving 1455 includes code for receiving, on a first set of subcarriers of the set of subcarriers, a first transmission. In some aspects, code for decoding 1460 includes code for decoding, according to a first mapping between the first set of subcarriers and a first set of spinal symbols of a plurality of spinal symbols, the first transmission to obtain the first set of spinal symbols. In some aspects, code for receiving 1455 includes code for receiving, on a second set of subcarriers, a second transmission. In some aspects, code for decoding 1460 includes code for decoding, according to a second mapping between the second set of subcarriers and a second set of spinal symbols of the plurality of spinal symbols, the second transmission to obtain the second set of spinal symbols.

The one or more processors 1410 include circuitry configured to implement (for example, execute) the code stored in the computer-readable medium/memory 1445, including circuitry for identifying 1415, circuitry for receiving 1420, circuitry for decoding 1425, circuitry for selecting 1430, circuitry for transmitting 1435, and circuitry for performing 1440. Processing with circuitry 1415-1440 may enable and cause the communications device 1400 to perform the method 1200 described with respect to FIG. 12, or any aspect related to it. For instance, in some aspects, circuitry for identifying 1415 includes circuitry for identifying a set of subcarriers, of a plurality of subcarriers, with a capacity metric that satisfies a threshold. In some aspects, circuitry for receiving 1420 includes circuitry for receiving, on a first set of subcarriers of the set of subcarriers, a first transmission. In some aspects, circuitry for decoding 1425 includes circuitry for decoding, according to a first mapping between the first set of subcarriers and a first set of spinal symbols of a plurality of spinal symbols, the first transmission to obtain the first set of spinal symbols. In some aspects, circuitry for receiving 1420 includes circuitry for receiving, on a second set of subcarriers, a second transmission. In some aspects, circuitry for decoding 1425 includes circuitry for decoding, according to a second mapping between the second set of subcarriers and a second set of spinal symbols of the plurality of spinal symbols, the second transmission to obtain the second set of spinal symbols.

More generally, means for communicating, transmitting, sending or outputting for transmission may include the one or more transceivers 324, one or more antenna 322 and/or processing system 316 of the UE 304 illustrated in FIG. 3, transceiver 1485 and/or antenna 1490 of the communications device 1400 in FIG. 14, and/or one or more processors 1410 of the communications device 1400 in FIG. 14. Means for communicating, receiving or obtaining may include the one or more transceivers 324, one or more antennas 322, and/or processing system 316 of the UE 304 illustrated in FIG. 3, transceiver 1485 and/or antenna 1490 of the communications device 1400 in FIG. 14, and/or one or more processors 1410 of the communications device 1400 in FIG. 14.

### Example Clauses

Implementation examples are described in the following numbered clauses:

Clause 1: A method of wireless communication by a transmitting device, comprising: identifying a set of subcarriers, of a plurality of subcarriers, with a capacity metric that satisfies a threshold; encoding a plurality of segments of data, using a spinal coding technique, to generate a plurality of spinal symbols having a first ordering; performing a first transmission of a first set of spinal symbols of the plurality of spinal symbols, wherein at least a subset of the first set of spinal symbols are on a first set of subcarriers of the set of subcarriers according to the first ordering; and performing a second transmission of a second set of spinal symbols of the plurality of spinal symbols different than the first set of spinal symbols, wherein the second set of spinal symbols are on a second set of subcarriers of the set of subcarriers, and wherein the second set of spinal symbols is selected from the plurality of spinal symbols according to a second ordering that is a reverse of the first ordering.

Clause 2: The method of Clause 1, wherein one or more spinal symbols of the first set of spinal symbols are on a subcarrier, of the plurality of subcarriers, excluded from the set of subcarriers.

Clause 3: The method of any one of Clauses 1-2, wherein the second set of spinal symbols is selected from remaining spinal symbols, of the plurality of spinal symbols, other than the first set of spinal symbols.

Clause 4: The method of Clause 3, wherein the plurality of spinal symbols have corresponding indexes that increase in accordance with the first ordering, and wherein the second set of spinal symbols are selected to have decreasing indexes of the plurality of spinal symbols.

Clause 5: The method of Clause 4, wherein the second set of spinal symbols includes a highest-indexed spinal symbol of the remaining spinal symbols other than the first set of spinal symbols.

Clause 6: The method of any one of Clauses 1-5, wherein the first set of subcarriers includes one or more higher-capacity subcarriers and one or more lower-capacity subcarriers, wherein a lower-indexed spinal symbol of the first set of spinal symbols is mapped to the one or more higher-capacity subcarriers and a higher-indexed spinal symbol of the first set of spinal symbols is mapped to the one or more lower-capacity subcarriers.

Clause 7: The method of Clause 6, wherein the lower-indexed spinal symbol is associated with an earlier node of a decoding process for the spinal coding technique and the higher-indexed spinal symbol is associated with a later node of the decoding process.

Clause 8: The method of any one of Clauses 1-7, wherein for the first transmission, remaining subcarriers of the plurality of subcarriers, other than the set of subcarriers, are mapped to untransmitted spinal symbols of the plurality of spinal symbols.

Clause 9: The method of any one of Clauses 1-8, wherein identifying the set of subcarriers further comprises selecting the set of subcarriers based on the capacity metric.

Clause 10: The method of any one of Clauses 1-9, wherein identifying the set of subcarriers further comprises receiving an indication of the set of subcarriers.

Clause 11: The method of any one of Clauses 1-10, further comprising transmitting an indication of the set of subcarriers.

Clause 12: The method of any one of Clauses 1-11, wherein the first set of subcarriers includes the second set of subcarriers.

Clause 13: The method of any one of Clauses 1-12, further comprising transmitting information indicating one or more of: a first mapping of the first set of spinal symbols to the first set of subcarriers, or a second mapping of the second set of spinal symbols to the second set of subcarriers.

Clause 14: A method of wireless communication by a receiving device, comprising: identifying a set of subcarriers, of a plurality of subcarriers, with a capacity metric that satisfies a threshold; receiving, on a first set of subcarriers of the set of subcarriers, a first transmission; decoding, according to a first mapping between the first set of subcarriers and a first set of spinal symbols of a plurality of spinal symbols, the first transmission to obtain the first set of spinal symbols; receiving, on a second set of subcarriers, a second transmission; and decoding, according to a second mapping between the second set of subcarriers and a second set of spinal symbols of the plurality of spinal symbols, the second transmission to obtain the second set of spinal symbols.

Clause 15: The method of Clause 14, wherein the second set of spinal symbols is selected from remaining spinal symbols other than the first set of spinal symbols.

Clause 16: The method of Clause 15, wherein the plurality of spinal symbols have corresponding indexes that increase in accordance with a first ordering, and wherein the second set of spinal symbols, according to a second ordering, have decreasing indexes of the plurality of spinal symbols.

Clause 17: The method of Clause 16, wherein the second set of spinal symbols includes a highest-indexed spinal symbol of the remaining spinal symbols other than the first set of spinal symbols.

Clause 18: The method of any one of Clauses 14-17, wherein the first set of subcarriers includes one or more higher-capacity subcarriers and one or more lower-capacity subcarriers, wherein a lower-indexed spinal symbol of the first set of spinal symbols is mapped to the one or more higher-capacity subcarriers and a higher-indexed spinal symbol of the first set of spinal symbols is mapped to the one or more lower-capacity subcarriers according to the first mapping.

Clause 19: The method of Clause 18, wherein the lower-indexed spinal symbol is associated with an earlier node of a decoding process for the spinal coding technique and the higher-indexed spinal symbol is associated with a later node of the decoding process.

Clause 20: The method of any one of Clauses 14-19, wherein for the first transmission, remaining subcarriers of the plurality of subcarriers, other than the set of subcarriers, are mapped to untransmitted spinal symbols of the plurality of spinal symbols according to the first mapping.

Clause 21: The method of any one of Clauses 14-20, wherein identifying the set of subcarriers further comprises selecting the set of subcarriers based on the capacity metric.

Clause 22: The method of any one of Clauses 14-21, wherein identifying the set of subcarriers further comprises receiving an indication of the set of subcarriers.

Clause 23: The method of any one of Clauses 14-22, further comprising transmitting an indication of the set of subcarriers.

Clause 24: The method of any one of Clauses 14-23, wherein the first set of subcarriers includes the second set of subcarriers.

Clause 25: The method of any one of Clauses 14-24, further comprising receiving information indicating the first mapping or the second mapping.

Clause 26: The method of any one of Clauses 14-25, wherein decoding the first transmission to obtain the first set of spinal symbols further comprises performing a first bubble decoding operation using a decoding process, wherein the first set of spinal symbols are associated with a set of nodes of the decoding process comprising only one of: even-indexed nodes of the decoding tree, or odd-indexed nodes of the decoding tree.

Clause 27: The method of Clause 26, wherein decoding the second transmission to obtain the second set of spinal symbols further comprises performing a second bubble decoding operation using the decoding process, wherein the second set of spinal symbols includes a spinal symbol associated with a highest-indexed node, of remaining nodes of the decoding process other than the set of nodes.

Clause 28: The method of any one or more of Clauses 1-27, further comprising ordering the plurality of subcarriers according to the channel metric, wherein at least one of the first mapping or the second mapping is based on the ordering

Clause 29: One or more apparatuses, comprising: one or more memories comprising executable instructions; and one or more processors configured to execute the executable instructions and cause the one or more apparatuses to perform a method in accordance with any one of Clauses 1-28.

Clause 30: One or more apparatuses configured for wireless communications, comprising: one or more memories; and one or more processors, coupled to the one or more memories, configured to cause the one or more apparatuses to perform a method in accordance with any one of Clauses 1-28.

Clause 31: One or more apparatuses configured for wireless communications, comprising: one or more memories; and one or more processors, coupled to the one or more memories, configured to perform a method in accordance with any one of Clauses 1-28.

Clause 32: One or more apparatuses, comprising means for performing a method in accordance with any one of Clauses 1-28.

Clause 33: One or more non-transitory computer-readable media comprising executable instructions that, when executed by one or more processors of one or more apparatuses, cause the one or more apparatuses to perform a method in accordance with any one of Clauses 1-28.

Clause 34: One or more computer program products embodied on one or more computer-readable storage media comprising code for performing a method in accordance with any one of Clauses 1-28.

Clause 35: One or more apparatuses configured for wireless communications, comprising: a processing system that includes one or more processors and one or more memories coupled with the one or more processors, the processing system configured to cause the one or more apparatuses to perform a method in accordance with any one of Clauses 1-28.

The foregoing disclosure provides illustration and description but is not intended to be exhaustive or to limit the aspects to the precise forms disclosed. Modifications and variations may be made in light of the above disclosure or may be acquired from practice of the aspects. No element, act, or instruction described herein should be construed as critical or essential unless explicitly described as such.

It will be apparent that systems or methods described herein may be implemented in different forms of hardware or a combination of hardware and software. The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, and/or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, and/or other such similar actions.

As used herein, the phrase “based on” is intended to mean “based at least in part on” or “based on or otherwise in association with” unless explicitly stated otherwise. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. An apparatus comprising a processing system that includes one or more processors and one or more memories coupled with the one or more processors, the processing system configured to cause a transmitting device to:
identify a set of subcarriers, of a plurality of subcarriers, with a capacity metric that satisfies a threshold;
encode a plurality of segments of data, using a spinal coding technique, to generate a plurality of spinal symbols having a first ordering;
perform a first transmission of a first set of spinal symbols of the plurality of spinal symbols, wherein at least a subset of the first set of spinal symbols are on a first set of subcarriers of the set of subcarriers according to the first ordering; and
perform a second transmission of a second set of spinal symbols of the plurality of spinal symbols different than the first set of spinal symbols, wherein the second set of spinal symbols are on a second set of subcarriers of the set of subcarriers, and wherein the second set of spinal symbols is selected from the plurality of spinal symbols according to a second ordering that is a reverse of the first ordering.

2. The apparatus of claim 1, wherein one or more spinal symbols of the first set of spinal symbols are on a subcarrier, of the plurality of subcarriers, excluded from the set of subcarriers.

3. The apparatus of claim 1, wherein the second set of spinal symbols is selected from remaining spinal symbols, of the plurality of spinal symbols, other than the first set of spinal symbols.

4. The apparatus of claim 3, wherein the plurality of spinal symbols have corresponding indexes that increase in accordance with the first ordering, and wherein the second set of spinal symbols are selected to have decreasing indexes of the plurality of spinal symbols.

5. The apparatus of claim 4, wherein the second set of spinal symbols includes a highest-indexed spinal symbol of the remaining spinal symbols other than the first set of spinal symbols.

6. The apparatus of claim 1, wherein the first set of subcarriers includes one or more higher-capacity subcarriers and one or more lower-capacity subcarriers, wherein a lower-indexed spinal symbol of the first set of spinal symbols is mapped to the one or more higher-capacity subcarriers and a higher-indexed spinal symbol of the first set of spinal symbols is mapped to the one or more lower-capacity subcarriers.

7. The apparatus of claim 6, wherein the lower-indexed spinal symbol is associated with an earlier node of a decoding process for the spinal coding technique and the higher-indexed spinal symbol is associated with a later node of the decoding process.

8. The apparatus of claim 1, wherein, for the first transmission, remaining subcarriers of the plurality of subcarriers, other than the set of subcarriers, are mapped to untransmitted spinal symbols of the plurality of spinal symbols.

9. The apparatus of claim 1, wherein to cause the transmitting device to identify the set of subcarriers, the processing system is configured to cause the transmitting device to select the set of subcarriers based on the capacity metric.

10. The apparatus of claim 1, wherein to cause the transmitting device to identify the set of subcarriers, the processing system is configured to cause the transmitting device to receive an indication of the set of subcarriers.

11. The apparatus of claim 1, wherein the processing system is configured to cause the transmitting device to transmit an indication of the set of subcarriers.

12. The apparatus of claim 1, wherein the first set of subcarriers includes the second set of subcarriers.

13. The apparatus of claim 1, wherein the processing system is configured to cause the transmitting device to transmit information indicating one or more of:
a first mapping of the first set of spinal symbols to the first set of subcarriers, or
a second mapping of the second set of spinal symbols to the second set of subcarriers.

14. The apparatus of claim 13, wherein the processing system is configured to cause the transmitting device to order the plurality of spinal symbols according to the capacity metric, wherein the first mapping or the second mapping is based on the ordering.

15. An apparatus comprising a processing system that includes one or more processors and one or more memories coupled with the one or more processors, the processing system configured to cause a receiving device to:
identify a set of subcarriers, of a plurality of subcarriers, with a capacity metric that satisfies a threshold;
receive, on a first set of subcarriers of the set of subcarriers, a first transmission;
decode, according to a first mapping between the first set of subcarriers and a first set of spinal symbols of a plurality of spinal symbols, the first transmission to obtain the first set of spinal symbols;
receive, on a second set of subcarriers, a second transmission; and
decode, according to a second mapping between the second set of subcarriers and a second set of spinal symbols of the plurality of spinal symbols, the second transmission to obtain the second set of spinal symbols.

16. The apparatus of claim 15, wherein the second set of spinal symbols is selected from remaining spinal symbols other than the first set of spinal symbols.

17. The apparatus of claim 16, wherein the plurality of spinal symbols have corresponding indexes that increase in accordance with a first ordering, and wherein the second set of spinal symbols, according to a second ordering, have decreasing indexes of the plurality of spinal symbols.

18. The apparatus of claim 17, wherein the second set of spinal symbols includes a highest-indexed spinal symbol of the remaining spinal symbols other than the first set of spinal symbols.

19. The apparatus of claim 15, wherein the first set of subcarriers includes one or more higher-capacity subcarriers and one or more lower-capacity subcarriers, wherein a lower-indexed spinal symbol of the first set of spinal symbols is mapped to the one or more higher-capacity subcarriers and a higher-indexed spinal symbol of the first set of spinal symbols is mapped to the one or more lower-capacity subcarriers according to the first mapping.

20. A method of wireless communication by a transmitting device, comprising:
identifying a set of subcarriers, of a plurality of subcarriers, with a capacity metric that satisfies a threshold;
encoding a plurality of segments of data, using a spinal coding technique, to generate a plurality of spinal symbols having a first ordering;
performing a first transmission of a first set of spinal symbols of the plurality of spinal symbols, wherein at least a subset of the first set of spinal symbols are on a first set of subcarriers of the set of subcarriers according to the first ordering; and
performing a second transmission of a second set of spinal symbols of the plurality of spinal symbols different than the first set of spinal symbols, wherein the second set of spinal symbols are on a second set of subcarriers of the set of subcarriers, and wherein the second set of spinal symbols is selected from the plurality of spinal symbols according to a second ordering that is a reverse of the first ordering.
